(19) United States
(12) Patent Application Publication
(10) Pub. No.: US 2016/0306581 A1
(43) Pub. Date: Oct. 20, 2016

(54) AUTOMATED CONFIGURATION OF STORAGE POOLS METHODS AND APPARATUS

(71) Applicant: INTERMODAL DATA, INC., Santa Clara, CA (US)

(72) Inventors: Kais Belgaied, San Jose, CA (US); Dinesh Bhat, Sunnyvale, CA (US); Donald James Brady, Woodland Park, CO (US); Richard Michael Elling, Ramona, CA (US); Nakul P. Saraiya, Palo Alto, CA (US); Prashanth K. Sreenivasa, Milpitas, CA (US); Cahya Adiansyah Masputra, San Jose, CA (US); Michael Pierre Mattsson, Redwood City, CA (US)

(21) Appl. No.: 15/099,182

(22) Filed: Apr. 14, 2016

Related U.S. Application Data
(60) Provisional application No. 62/147,919, filed on Apr. 15, 2015.

(51) Int. Cl. G06F 3/06

(52) U.S. Cl. CPC G06F 3/0631; G06F 3/0604; G06F 3/0683

(57) ABSTRACT

A system, method, and apparatus for the automated configuration of storage pools are disclosed. An example method includes determining, as available storage devices, storage devices within a storage system that have availability to be placed into a storage pool and first filtering, based on a first portion of storage requirement information received from a third-party, the available storage devices to eliminate a first set of the available storage devices and determine remaining storage devices. The method also includes second filtering, based on a second portion of the storage requirement information, the remaining storage devices after the first filtering to eliminate a second set of the remaining storage device. The method further includes designating the storage devices remaining after the first and second filtering as identified storage devices and creating the storage pool based on the storage requirement information using at least one of the identified storage devices.

### PRIORITY CLAIM

The present application claims priority to and the benefit of U.S. Provisional Patent Application No. 62/147,919, filed on Apr. 15, 2015, the entirety of which is incorporated herein by reference.

### BACKGROUND

Known storage services are generally a labyrinth of configuration settings and tools. Any given storage service includes a combination of physical and virtualized hardware combined with software-based storage rules and configurations. Each hardware and software resource of the storage service is typically designed or provided by a third-party provider. A storage service provider makes the hardware and software storage resources available in a central location to provide users with an array of different data storage solutions. Users access the storage service provider to specify a desired storage service. However, the storage service providers generally leave the complexity involved in combining hardware and software resources provided by different third-party providers to the users. This combination of different third-party hardware/software storage resources oftentimes creates an overly complex mesh of heterogeneous, unstable storage resource management tools and commands. Frequently, inputs, outputs, and behaviors of the different tools are inconsistent or counterintuitive, which further complicates a user's management (or even management by the storage service provider) of a storage service. Additionally, updates to the underlying storage resources by the third-party providers have to be properly integrated and propagated through the storage services while maintaining consistent system performance, with the updates being properly communicated to the appropriate individuals. Otherwise, configurations between the different storage resources may become misaligned or faulty.

Companies and other entities (e.g., users) that use storage services typically employ specialized storage system experts to navigate the storage system labyrinth and handle updates to the underlying resources. The system experts are knowledgeable regarding how to use the third-party storage system tools for configuring and maintaining the corresponding storage system resources to create a complete storage service. Such experts adequately perform relatively simple storage configurations or operations. However, experts become overburdened or exposed when trying to formulate relatively complex storage operations, which generally involves multiple compound storage operations. There is accordingly a significant cost to implement, triage, and maintain relatively complex storage systems and exponential costs to address failures. Further, many small to medium-sized users cannot afford the relatively high cost of experts to implement even a relatively simple storage service.

Additionally, system experts are tasked with manually configuring a new storage service or storage system. The system experts determine generally a limited set of system constraints based on business rules provided by a client or storage system owner. The system experts also manually determine what storage devices and/or resources are available for the new system that match or coincide with the business rules and/or constraints. The selected storage devices and/or resources, business rules, and system constraints are documented and mapped in spreadsheets or other rudimentary system tracking tools, which are used by system developers to configure and provision the storage service. Such a manual configuration may be acceptable for relatively simple systems with few business rules, constraints, and devices. However, this manual approach becomes unwieldy or unacceptable for relatively large dynamic storage systems with tens to thousands of potential devices where new devices may become available everyday. This manual approach also generally does not work for more complex business rules and/or constraints.

### SUMMARY

The present disclosure provides a new and innovative system, method, and apparatus for the automated configuration of storage pools. An example storage service provider is configured to automatically create drive pools based on storage requirements provided by a third party. The storage service provider uses a series of filters that are configured to eliminate available drivers based on the storage requirements to determine a pool of acceptable drives. The filters are configured such that once a drive is eliminated from consideration, the drive is not considered by downstream filters. The example storage service provider uses one or more routines and/or algorithms to select the acceptable drives to increase or maximize path diversity. Such a configuration enables the automatic customization of any storage pool based on storage requirements provided by a requesting party. This enables highly customized storage pools to be created regardless of the size of the applications.

In an embodiment, an apparatus for configuring a storage pool includes a pool planner processor and a node manager processor. The example pool planner processor is configured to receive storage requirement information and determine, as available storage devices, storage devices within a storage system that have availability to be placed into the storage pool. The pool planner processor is also configured to apply a first filter to the available storage devices to eliminate a first set of the available storage devices and determine remaining storage devices, the first filter including a first portion of the storage requirement information. After applying the first filter, the pool planner processor is configured to apply a second filter to the remaining storage devices after the first filter to eliminate a second set of the remaining storage devices, the second filter including a second portion of the storage requirement information. The pool planner processor is further configured to designate the storage devices remaining after the second filter as identified storage devices. The example node manager processor is configured to receive the storage requirement information for the storage pool from a third-party, transmit the storage information to the pool planner processor, and create the storage pool based on the storage requirement information using at least one of the identified storage devices. The node manager processor is also configured to make the storage pool available to the third-party.

In another embodiment, a method for configuring a storage pool includes receiving storage requirement information for the storage pool from a third-party and determining, as available storage devices, storage devices within a storage system that have availability to be placed into the storage pool. The method also includes first filtering, based on a first portion of the storage requirement information, the available storage devices to (i) eliminate a first set of the available storage devices and (ii) determine remaining storage devices. The method further includes second filtering, based on a second portion of the storage requirement information, the remaining storage devices after the first filtering to eliminate a second set of the remaining storage device. The method moreover includes designating the storage devices remaining after the first and second filtering as identified storage devices and creating the storage pool based on the storage requirement information using at least one of the identified storage devices. The method additionally includes making the storage pool available to the third-party.

Additional features and advantages of the disclosed system, method, and apparatus are described in, and will be apparent from, the following Detailed Description and the Figures.

### BRIEF DESCRIPTION OF THE FIGURES

FIG. 1 shows a diagram of a storage service environment including a node manager and a platform expert, according to an example embodiment of the present disclosure.

FIG. 2 shows a diagram of an example graphical representation of a storage service, according to an example embodiment of the present disclosure.

FIG. 3 shows a diagram of access layers to the example node manager of FIG. 1, according to an example embodiment of the present disclosure.

FIGS. 4A, 4B, 5, 6, and 7 illustrate flow diagrams showing example procedures to create, destroy, and import a storage service using the example node manager and/or the platform expert of FIGS. 1 to 3, according to example embodiments of the present disclosure.

FIG. 8 shows a diagram illustrating how the storage service environment of FIG. 1 may be used to create a storage pool of drives, according to an example embodiment of the present disclosure.

FIGS. 9 to 11 show diagrams of examples of drive assignment that may be performed by the node manager of FIGS. 1 to 3 and 8, according to example embodiments of the present disclosure.

FIG. 12 shows a diagram of a scalable pool planner operable within the storage service environment of FIGS. 1 to 3 and 8, according to example embodiments of the present disclosure.

### DETAILED DESCRIPTION

The present disclosure relates in general to a method, apparatus, and system for providing management and representation of storage services and, in particular, to a method, apparatus, and system that provides an abstracted, consistent, unified, and common view of storage service resources and/or storage services to enable streamlined storage services management. The example method, apparatus, and system disclosed herein include a node manager (e.g., a server or processor) and a platform expert (e.g., a server or processor) configured to provide management and control of storage services (e.g., storage pools). As disclosed in more detail below, the example node manager is configured to enable users to specify a storage service and accordingly create/provision the storage service. The example node manager is also configured to enable third-party providers of hardware and software to access/update/configure the underlying storage resources and propagate those changes through the plurality of hosted storage services. The example platform expert is configured to provide users and other administrators control plane management and visibility of the hardware/software storage resources that comprise a storage service.

As disclosed herein, a user includes an individual, a company, or other entity that uses or otherwise subscribes to a storage service. A user includes an administrator or other person/entity tasked with requesting, modifying, or otherwise managing a storage service. A user also includes employees or other users of a storage service. A user accesses a storage service via a user device, which may include any computer, laptop computer, server, tablet computer, workstation, smartphone, smartwatch, smart-eyewear, etc.

A storage service provider includes an entity configured to provide storage services to one or more users based, for example, on a service level agreement (“SLA”). A storage service provider hosts or otherwise manages a suite of hardware and/or software storage resources (e.g., system resources) that are combinable and/or configurable based on the storage requirements of a user. Collectively, a configuration of hosted hardware and/or software storage resources provisioned for a user is a storage service. Each storage resource includes one or more objects or parameters that define or otherwise specify how the storage resource is to be provisioned, configured, or interfaced with other storage resources.

Hardware storage resources may include physical devices such as, for example, solid state drives (“SSDs”), hard disk drives (“HDDs”), small computer system interfaces (“SCSIs”), serial attached SCSI (“SAS”) drives, near-line (“NL”)-SAS drives, serial AT attachment (“ATA”) (“SATA”) drives, Dynamic random-access memory (“DRAM”) drives, synchronous dynamic random-access memory (“SDRAM”) drives, etc. Hardware storage resources may be virtualized across one or more physical drives. Software storage resources include configurations and/or protocols used to configure the physical resources. For instance, software resources may include network protocols (e.g., ATA over Ethernet (“AoE”)), file system specifications (e.g., network file system (“NFS”) specifications, data storage configurations (e.g., redundant array of independent disks (“RAID”) configurations), volume manager specifications (e.g., a ZFS volume manager), etc.

As disclosed herein, third-party providers design, develop, produce, and/or make available the hardware and/or software storage resources for the storage service providers. For example, a third-party provider may manufacture an SSD that is owned and operated by a storage service provider. In another example, a third-party provider provides a combined file system and logical volume manager for use with virtualized storage drives. In these examples, the third-party providers specify configurations for the resources used by the storage service provider. The third-party providers may also periodically update or change the configurations of the resources (e.g., a firmware or software update to address bugs or become forward compatible).

While the example, method, and apparatus disclosed herein use a Layer-2 Ethernet communication medium that includes AoE as the network protocol for communication and block addressing, it should be appreciated that the example, method, and apparatus may also be implemented using other protocols within Layer-2 including, for example, Address Resolution Protocol (“ARP”), Synchronous Data Link Control (“SDLC”), etc. Further, the example, method, and apparatus may further be implemented using protocols of other layers, including, for example, Internet Protocol (“IP”) at the network layer, Transmission Control Protocol (“TCP”) at the transport layer, etc.

### Example Storage Service Environment

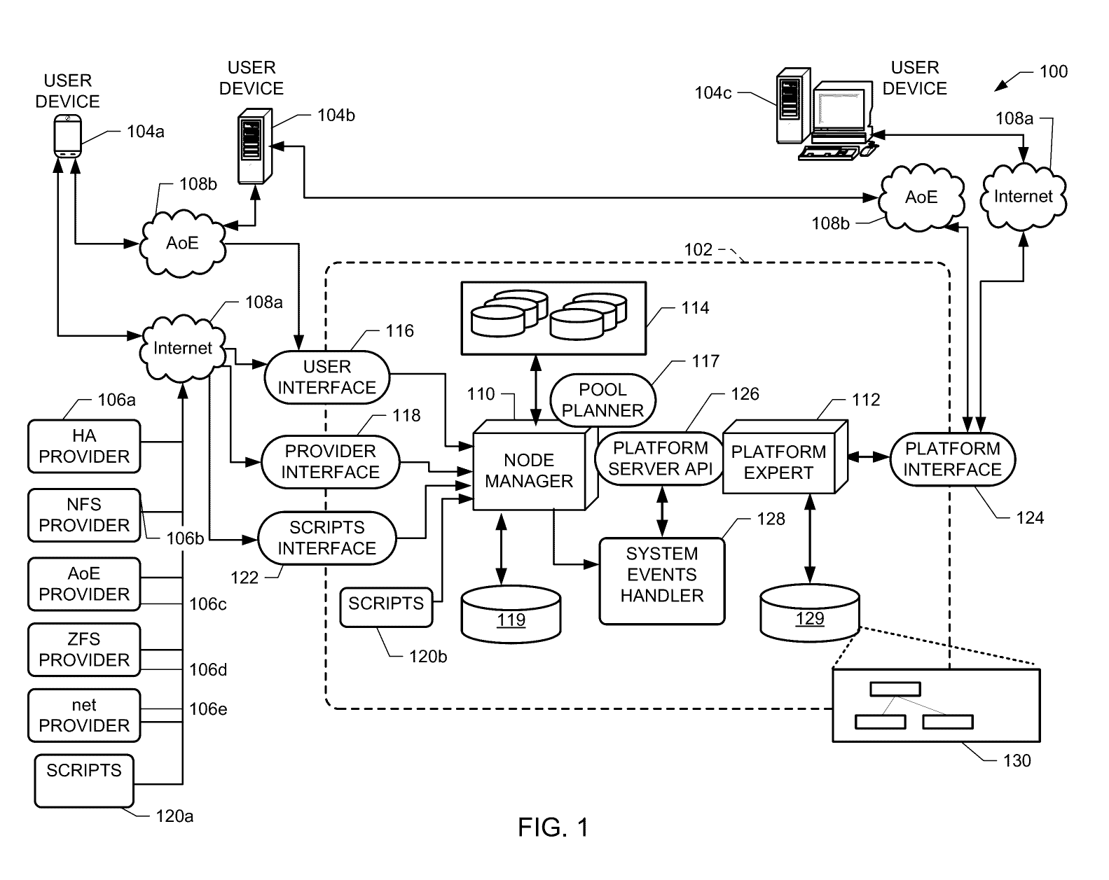

FIG. 1 shows an example storage service environment 100, according to an example embodiment of the present disclosure. The example environment 100 includes a storage service provider 102, user devices 104, and third-party providers 106. The provider 102, user devices 104, and/or third-party providers 106 are communicatively coupled via one or more networks 108 including, for example, the Internet 108a and/or an AoE network 108b. As mentioned above, the user devices 104 may include any computer, laptop computer, server, processor, workstation, smartphone, tablet computer, smart-eyewear, smartwatch, etc. The example third-party providers 106 include a high-availability (“HA”) storage provider 106a, a NFS provider 106b, an AoE provider 106c, a ZFS provider 106d, and a NET provider 106e. It should be appreciated that the example environment 100 can include fewer or additional third-party providers including, for instance, third-party providers for physical and/or virtual storage drives.

The example storage service provider 102 is configured to provide storage services to users and includes a node manager 110 and a platform expert 112. The example storage service provider 102 also includes (or otherwise communicatively coupled to) storage devices 114 that are configured to provide or host storage services for users. The storage devices 114 may be located in a centralized location and/or distributed across multiple locations in, for example, a cloud computing configuration. Further, while the storage service provider 102 is shown as being centralized, it should be appreciated that the features and/or components of the provider 102 may be distributed among different locations. For example, the node manager 110 may be located in a first location and the platform expert 112 may be located in a second different location. Moreover, while FIG. 1 shows the node manager 110 and the platform expert 112 as being included within the storage service provider 102, it should be appreciated that either or both of the devices 110 and 112 may be implemented or operated by another entity and communicatively coupled via one or more networks. The node manager 110 and/or the platform expert 112 may be implemented by one or more devices including servers, processors, workstations, cloud computing frameworks, etc. The node manager 110 may be implemented on the same device as the platform expert 112. Alternatively, the node manager 110 may be implemented on a different device from the platform expert 112.

Further, it should be appreciated that at least some of the features of the platform expert 112 may additionally or alternatively be performed by the node manager 110. For example, in some embodiments the node manager 110 may be configured to abstract and graphically (or visually) represent a storage service. Likewise, at least some of the features of the node manager 110 may additionally or alternatively be performed by the platform expert 112. The node manager 110 and/or the platform expert 112 (or more generally the storage service provider 102) may include a machine-accessible device having instructions stored thereon that are configured, when executed, to cause a machine to at least perform the operations and/or procedures described above and below in conjunction with FIGS. 1 to 7.

The node manager 110 may also include or be communicatively coupled to a pool planner 117 (e.g., a pool planner processor, server, computer processor, etc.). The example pool planner 117 is configured to select drives (e.g., portions of the storage devices 114), objects, and/or other resources based on criteria, requirements, specifications, or SLAs provides by users. The pool planner 117 may also build a configuration of the storage devices 114 based on the selected drives, objects, parameters, etc. In some instances, the pool planner 117 may use an algorithm configured to filter drives based on availability and/or user specifications.

The example node manager 110 is configured to provision and/or manage the updating of the storage devices 114. For instance, the node manager 110 enables users to perform or specify storage specific operations for subscribed storage services. This includes provisioning a new storage service after receiving a request from a user. The example storage service provider 102 includes a user interface 116 to enable the user devices 104 to access the node manager 110. The user interface 116 may include, for example, a Representational State Transfer (“REST”) application programmable interface (“API”) and/or JavaScript Object Notation (“JSON”) API.

The example node manager 110 is also configured to enable the third-party providers 106 to update and/or modify objects of storage resources hosted or otherwise used within storage services hosted by the storage service provider 102. As mentioned above, each third-party provider 106 is responsible for automatically and/or proactively updating objects associated with corresponding hardware/software storage resources. This includes, for example, the NFS provider 106b maintaining the correctness of NFSs used by the storage service provider 102 within the storage devices 114. The example storage service provider 102 includes a provider interface 118 that enables the third-party providers 106 to access the corresponding resource. The provider interface 118 may include a REST API, a JSON API, or any other interface.

The third-party providers 106 access the interface 118 to request the node manager 110 to update one or more objects/parameters of a storage resource. In other embodiments, the third-party providers 106 access the interface 118 to directly update the objects/parameters of a storage resource. In some embodiments, the third-party providers 106 may use a common or global convention to maintain, build, and/or populate storage resources, objects/parameters of resources, and/or interrelations of storage resources. Such a configuration enables the node manager 110 via the third-party providers 106 to create (and re-create) relationships among storage resources in a correct, persistent, consistent, and automated way without disrupting storage services.

As disclosed herein, persistent relationships among storage resources means that the creation, updating, or deletion of configuration information outlives certain events. These events include graceful (e.g., planned, user initiated, etc.) and/or abrupt (e.g., events resulting from a software or hardware failure) restarting of a storage system. The events also include the movement of a service within a HA cluster and/or a migration of a storage pool to a different cluster such the migrated storage pool retains the same configuration information. In other words, a persistent storage resource has stable information or configuration settings that remain the same despite changes or restarts to the system itself.

The example node manager 110 of FIG. 1 is communicatively coupled to a resource data structure 119 (e.g., a memory configured to store resource files). The resource data structure 119 is configured to store specifications and/or copies of third-party storage resources. In the case of software-based storage resources, the data structure 119 stores one or more copies (or instances) of configured software that may be deployed to hardware storage resources or used to configure hardware resources. The data structure 119 may also store specifications, properties, parameters, or requirements related to the copied software (or hardware) storage resources. The specifications, properties, parameters, or requirements may be defined by a user and/or the third-party.

The node manager 110 is configured to use instances of the stored storage resources to provision a storage service for a user. For instance, the node manager 110 may copy a ZFS file manager (i.e., a software storage resource) from the data structure 119 to provision a storage pool among the storage devices 114. The ZFS file manager may have initially been provided to the node manager 110 (and periodically updated) by the ZFS provider 106d. In this instance, the node manager 110 configures the storage pool to use the ZFS file manager, which is a copied instance of the ZFS manager within the data structure 119.

The example node manager 110 is also configured to store to the data structure 119 specifications, parameters, properties, requirements, etc. of the storage services provisioned for users. This enables the node manager 110 to track which resources have been instantiated and/or allocated to each user. This also enables the node manager 110 (or the third-party providers 106) to make updates to the underlying resources by being able to determine which storage services are configured with which storage resources.

The example storage service provider 102 also uses scripts 120 to enable users to manage storage resources. The scripts 120 may include scripts 120a that are external to the storage service provider 102 (such as a HA service), which may be provided by a third-party and scripts 120b that are internal to the storage service provider 102 (such as a pool planner script). The external scripts 120a may access the storage resources at the node manager 110 via a script interface 122. The scripts 120 may include tools configured to combine storage resources or assist users to specify or provision storage resources. For instance, a pool planning script may enable users to design storage pools among the storage devices 114.

The example storage service provider 102 also includes a platform expert 112 that is configured to provide users a consistent, unified, common view of storage resources, thereby enabling higher level control plane management. The platform expert 112 is configured to determine associations, dependencies, and/or parameters of storage resources to construct a single point of view of a storage service or system. In other words, the platform expert 112 is configured to provide a high level representation of a user's storage service by showing objects and interrelationships between storage resources to enable relatively easy management of the storage service without the help from expensive storage system experts. This storage resource abstraction (e.g., component abstraction) enables the platform expert 112 to determine and provide a more accurate and reduced (or minimized) view of a storage service that is understandable to an average user.

The platform expert 112 is configured to be accessed by the user devices 104 via a platform interface 124, which may include any REST API, JSON API, or any other API or web-based interface. In some embodiments, the platform interface 124 may be combined or integrated with the user interface 116 to provide a single user-focused interface for the storage service provider 102. The platform expert 112 is also configured to access or otherwise determine resources within storage services managed by the node manager 110 via a platform expert API 126, which may include any interface. In some embodiments, a system events handler 128 is configured to determine when storage services are created, modified, and/or deleted and transmit the detected changes to the platform expert 112.

The example platform expert 112 is configured to be communicatively coupled to a model data structure 129, which is configured to store graphical representations 130 of storage services. As discussed in more detail below, a graphical representation 130 provides a user an abstracted view of a storage service including underlying storage resources and parameters of those resources. The example graphical representation 130 also includes features and/or functions that enable a user to change or modify objects or resources within a storage service.

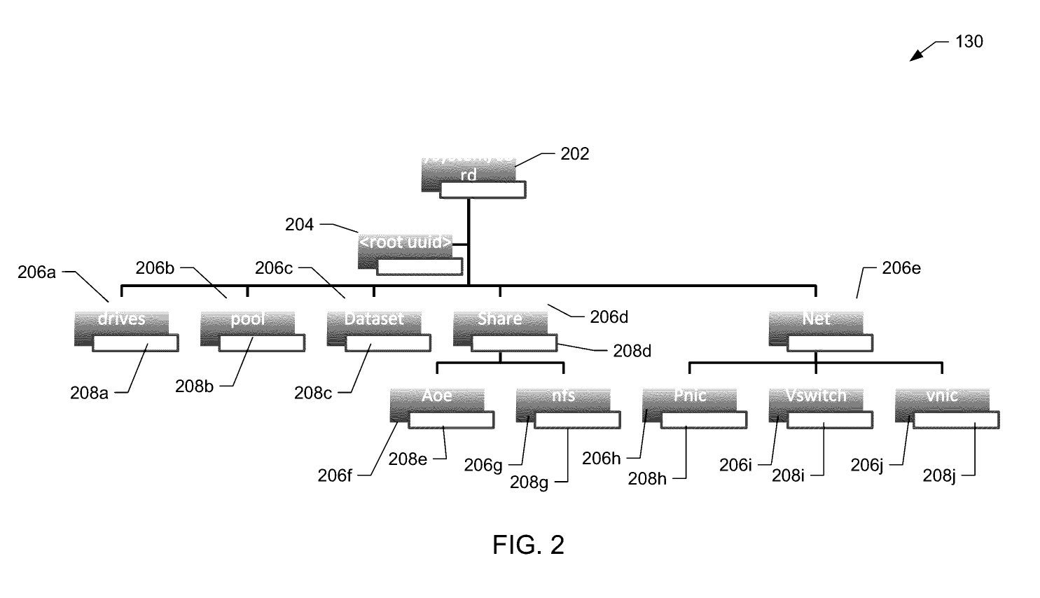

FIG. 2 shows a diagram of an example graphical representation 130 of a storage service, according to an example embodiment of the present disclosure. The graphical representation 130 represents or abstracts a storage service and underlying software and/or hardware storage resources into a resource-tree structure that displays objects/parameters and relationships between resources/objects/parameters. Each storage service provisioned by the node manager 110 among the storage devices 114 includes a root address 202 and a universally unique identifier (“UUID”) 204. The storage service also includes hardware and software storage resources 206 (e.g., the storage resources 206a to 206j), which are represented as nodes within the resource-tree structure. Each of the nodes 206 represents at least one object and is assigned its own UUID. The node or object specifies or includes at least one immutable and/or dynamic parameter 208 (e.g., the parameters 208a to 208j) related to the respective storage resource. The parameters may include, for example, status information of that storage resource (e.g., capacity, latency, configuration setting, etc.). The parameters may also include, for example, statistical information for that object and/or resource (e.g., errors, data access rates, downtime/month, etc.). The use of the UUIDs for each object enables the platform expert 112 to abstract physical hardware to a naming/role convention that allows physical and/or virtual objects to be treated or considered in the same manner. As such, the platform expert 112 provides users a mapping to the physical hardware resources in conjunction with the software resources managing the data storage/access to the hardware.

The example platform expert 112 is configured to create the graphical representation 130 based on stored specifications of the storage resources that are located within the resource data structure 119. In an example, the platform expert 112 uses the platform expert API 126 and/or the system events handler 128 to monitor the node manager server 110 for the creation of new storage services or changes to already provisioned storage services. The platform expert 112 may also use one or more platform libraries stored in the data structure 129, which define or specify how certain storage resources and/or objects are interrelated or configured.

For instance, the system events handler 128 may be configured to plug into a native events dispatching mechanism of an operating system of the node manager 110 to listen or monitor specified events related to the provisioning or modifying of storage services. After detecting a specified event, the example system events handler 128 determines or requests a UUID of the storage service (e.g., the UUID 204) and transmits a message to the platform expert 112. After receiving the message, the example platform expert 112 is configured to make one or more API calls to the node manager 110 to query the details regarding the specified storage service. In response, the node manager 110 accesses the resource data structure 119 to determine how the specified storage service is configured and sends the appropriate information to the platform expert 112. The information may include, for example, configurations of hardware resources such as device type, storage capacity, storage configuration, file system type, attributes of the file system and volume manager, etc. The information may also include parameters or objects of the resources and/or defined interrelationships among the resources and/or objects. The example platform expert 112 is configured to use this information to construct the graphical representation 130 using, in part, information from the platform libraries. For instance, a library may define a resource tree structure for a particular model of SSD configured using a RAID01 storage configuration.

The example platform expert 112 is also configured to assign UUIDs to the storage resources and/or objects. The platform expert 112 stores to the data structure 129 a reference of the UUIDs to the specific resources/objects. Alternatively, in other embodiments, the node manager 110 may assign the UUIDs to the resources/objects at the time of provisioning a storage service. In some instances, a library file may define how resources and/or objects are to be created and/or re-created within a graphical representation 130. This causes the platform expert 112 to create and re-create different instances of the same resources/objects in a correct, repeatable (persistent), consistent, and automated way based on the properties (e.g., class, role, location, etc.) of the resource or object. For example, the platform expert 112 may be configured to use a bus location of a physical network interface controller (“NIC”) (e.g., a hardware storage resource) to determine a UUID of the resource. The bus location may also be used by the platform expert 112 to determine the location of the NIC resource within a graphical representation 130.

The code (e.g., an output from a JSON interface) below shows an example specification of a graphical representation determined by the platform expert 112. The code includes the assignment of UUIDs to storage resources and the specification of objects/parameters to the resources.

/system/cord$ json -f
share/aoe/0e52855b-a25c-59dd-b553-a24a8ce98e5c/devnode.json
{

“uuid”: “0e52855b-a25c-59dd-b553-a24a8ce98e5c”,
class”: “aoetlu”,
“dataset_uuid”: “79a94913-b2ce-5748-b50c-6a44684bbaa0”,
“aoe_pool_num”: “42”,
aoe_vol_num”: “17”,
filename”: “/aoe_luns/aoe_pool42_vol17/aoet_lu_42_17”,
role”: “netdrv”,
guid”: “600100400C008C370000546B822F0045”,
“size”: “1099511627776”,
“write_protect”: “false”,
“write_cache_enable”: “true”,
“version”: “1.0”,
“actionable”: “yes”

}

The code below shows another example specification of a graphical representation determined by the platform expert 112. The code includes the assignment of UUIDs to storage resources and the specification of objects/parameters to the resources.

[root@congo /var/tmp/cord-python]# json -f
/system/cord/share/nfs/177df742-43dd-590f-b6ce-
7d072fd11ad4/devnode.json
{

“uuid”: “177df742-43dd-590f-b6ce-7d072fd11ad4”,
“type”: “NFSv3”,
“dataset_uuid”: “8174c679-b430-5dec-b2b4-1dd4b1f0c2b7”,
“version”: “1.0”,
“actionable”: “yes”

}
[root@congo /var/tmp/cord-python]# json -f
/system/cord/dataset/8174c679-b430-5dec-b2b4-
1dd4b1f0c2b7/devnode.json
{

```
  “class”: “dataset”,
“actionable”: “yes”,
“version”: “1.0”,
“name”: “demo_nfs_datastore”,
“dataset_name”: “cordstor-27797606/nfs/demo_nfs_datastore”,
“uuid”: “8174c679-b430-5dec-b2b4-1dd4b1f0c2b7”,
“type”: “FILESYSTEM”,
“creation”: “2014-11-18T17:34:40Z”,
“used”: “19456”,
“available”: “21136607657984”,
“referenced”: “19456”,
“logicalused”: “9728”,
“logicalreferenced”: “9728”,
“compressratio”: “1.00”,
“refcompressratio”: “1.00”,
“quota”: “0”,
“reservation”: “0”,
“refquota”: “0”,
“refreservation”: “0”,
“compression”: “OFF”,
“recordsize”: “131072”,
“mounted”: “YES”,
“mountpoint”: “/nfs_shares/demo_nfs_datastore”,
“usedbysnapshots”: “0”,
“usedbydataset”: “19456”,
“usedbychildren”: “0”,
“usedbyrefreservation”: “0”,
“sync”: “STANDARD”,
“written”: “19456”,
“pool_uuid”: “57356387-1caf-59f5-9273-8033ca0d8d06”,
“protocol”: “NFS”,
  “coraid:share”: “{\“type\”: \“NFSv3\” }”
```

}

The platform expert 112 is also configured to enable users to modify the underlying resources and/or objects of a storage service via the graphical representation 130. As described, the graphical representation 130 provides an abstracted view of a storage service including underlying resources/objects. Accordingly, a user's manipulation of the graphical representation 130 enables the platform expert 112 to communicate the changes to the resources/objects to the node manager 110, which then makes the appropriate changes to the actual storage service. An expert is not needed to translate the graphical changes into specifications hardcoded into a file system or storage system. For instance, the platform expert 112 may provide one or more applications/tools to enable users to view/select additional storage resources and automatically populate the selected resources into the resource-tree based on how the selected resources are defined to be related to the already provisioned resources. In these instances, the platform expert 112 may operate in conjunction with the node manager 110 where the platform expert 112 is configured to update the graphical representation 130 and the node manager 110 is configured to update the storage services located on the storage devices 114 and/or the specification of the storage service stored within the resource data structure 119.

The use of the graphical representations 130 enables the platform expert 112 to operate as a user-facing pseudo file system and provide convenient well-known file-based features. For example, the platform expert 112 is configured to enable a user to store point-in-time states/views (e.g., a snapshot) of the graphical representation 130 of the storage service. Further, the platform expert 112 may include tools that work on files and file systems for changing the resources/objects, where the file/file system is replaced with (or includes) resources/objects. Further, the node manager 110 may be configured to determine the storage configuration of a service based on the graphical representation alone (or a machine-language version of the graphical representation condensed into a two-dimensional structure), thereby eliminating (or reducing) the need for specialized tools (or experts) to extract configuration information from the platform expert 112 and/or each of the graphical representations 130.

The platform expert 112 accordingly provides a single point interface via the graphical representation 130 for the orchestration layer to quickly gather and stitch up a global view of storage service provider applications (and incorporated third-party applications from the third-party providers 106) and perform intelligent storage actions such as rebalancing. The structure of the graphical representation 130 in conjunction with the configuration of storage resources enables the platform expert 112 to parse storage services with automated tools. Further, the configuration of the platform expert 112 is configured to provide users arbitration for accessing and updating the graphical representations 130.

The platform expert 112 may use the graphical representation 130 to re-create resource topology on another system or storage service to facilitate, for example, debugging and/or serviceability. The platform expert 112 may also use the graphical representation 130 to re-create storage service set-ups independent of MAC addresses because the individual resources/objects of the graphical representation 130 are identified based on UUIDs and not any hardware-specific identifiers. Further, the platform expert 112 may synchronization the provision of the storage service represented by the graphical representation 130 with other storage services based on the same resource architecture/configuration. For example, in clustered environments, node managers 110 across cluster members or service providers may participate in synchronizing states for storage services. The nature of the graphical representation 130 as an abstraction of the storage services provides coherency across multiple platform experts 112 and/or distributed graphical representations 130.

In an example, initial boot-up synchronization instantiates the platform expert 112, which is configured to communicate with a device discovery daemon for the hardware specific resources/objects needed to prepare the graphical representation 130 or resource-tree. The node manager 110 uses the graphical representation 130 to annotate the resources/objects within the corresponding roles by accessing the roles/objects/resources from the resource data structure 119 (created at installation or provisioning of a storage service). It should be appreciated that the data structure 119 also includes the hardware resource information for object creation within the graphical representation 130 by the platform expert 112.

It should be appreciated that the combination of the node manager 110 with the platform expert 112 provides consistency in storage object identification and representation for users. The use of the graphical representation 130 of storage services enables the platform expert 112 to provide a streamlined interface that provides a sufficient description (and modification features) of the underlying storage resources. The graphical representations 130 managed by the platform expert 112 accordingly serves as the source of truth and authoritative source for configurations, state, status, and statistics of the storage service and underlying storage resources. Further, any changes made to resources/objects by the third-party providers are identified by the platform expert 112 to be reflected in the appropriate graphical representations 130.

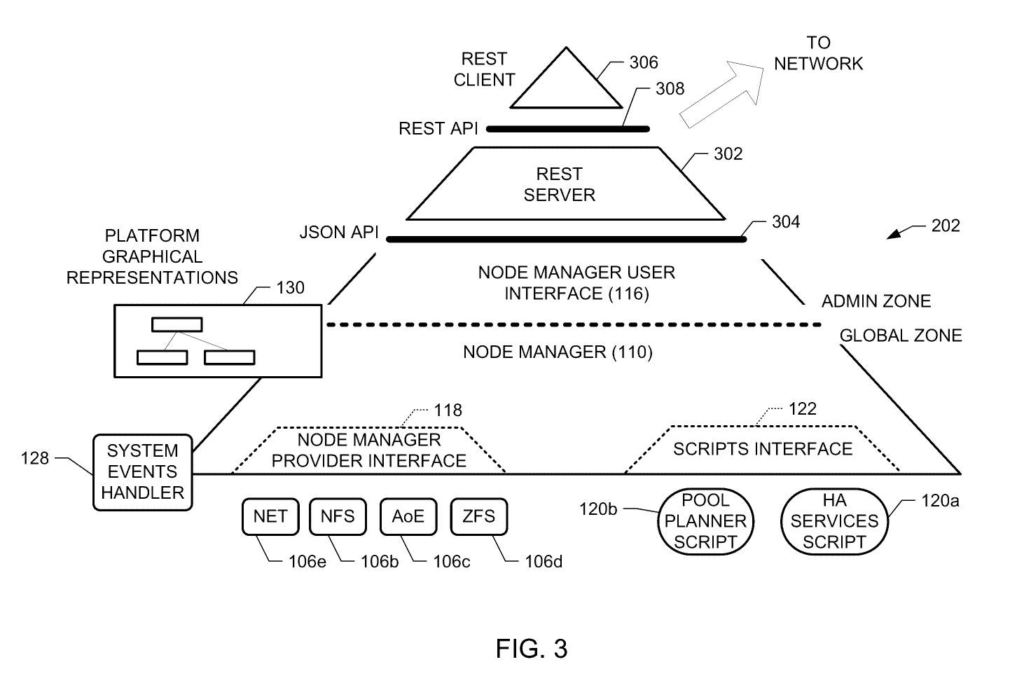

FIG. 3 shows a diagram of access layers to the example node manager 110, according to an example embodiment of the present disclosure. As discussed above in conjunction with FIG. 1, the example node manager 110 communicatively couples to the user devices 104 via the user interface 116, which may be located within an administrator zone of the storage service provider 102. The user interface 116 may be connected to the user devices 104 via a REST server 302 and a JSON API 304. The REST server 302 may be connected to the user devices 104 via a REST Client 306 and a REST API 308. The REST server 302 and/or the REST Client 306 may be configured to authenticate and/or validate user devices 104 prior to transmitting requests to the node manager 110. Such a configuration ensures that the user devices 104 provide information in a specified format to create/view/modify storage services. Such a configuration also enables the user devices 104 to view/modify storage services through interaction with the graphical representation 130. The configuration of interface components 302 to 308 accordingly enables the user devices 104 to submit requests to the node manager 110 for storage services and/or access graphical representations 130 to view an abstraction of storage services.

The example node manager 110 is connected within a global zone to the third-party providers 106 via the provider interface 118. The third-party providers 106 access the interface 118 to modify, add, remove, or otherwise update storage resources at the node manager 110. The node manager 110 is configured to propagate any changes to storage resources through all instances and copies of the resource used within different storage services. Such a configuration ensures that any changes to storage resources made by the third-party providers 106 are reflected throughout all of the hosted storage services. This configuration also places the third-party providers 106 in charge of maintaining their own resources (and communicating those changes), rather than having the node manager 110 query or otherwise obtain updates to storage resources from the providers 106. As discussed above, the example system events handler 128 monitors for any changes made to the storage resources and transmits one or more messages to the platform expert 112 indicating the changes, which enables the platform expert 112 to update the appropriate graphical representations 130.

The example node manager 110 is also connected within a global zone to scripts 120 (e.g., the pool planner script 120b and the HA services script 120a) via the scripts interface 122. The scripts interface 122 enables external and/or internal scripts and tools to be made available by the node manager 110 for user management of storage services. The scripts 120 may be located remotely from the node manager 110 and plugged into the node manager 110 via the interface 122.

### Flowcharts of Example Procedures

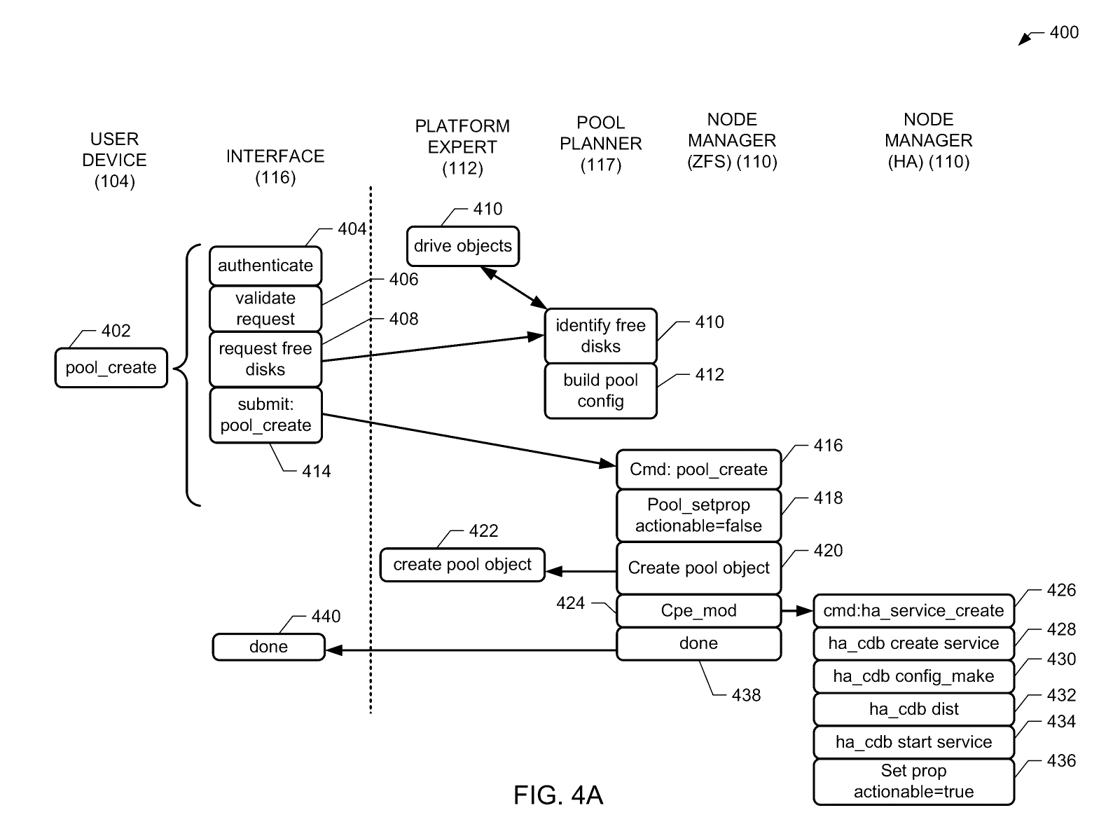

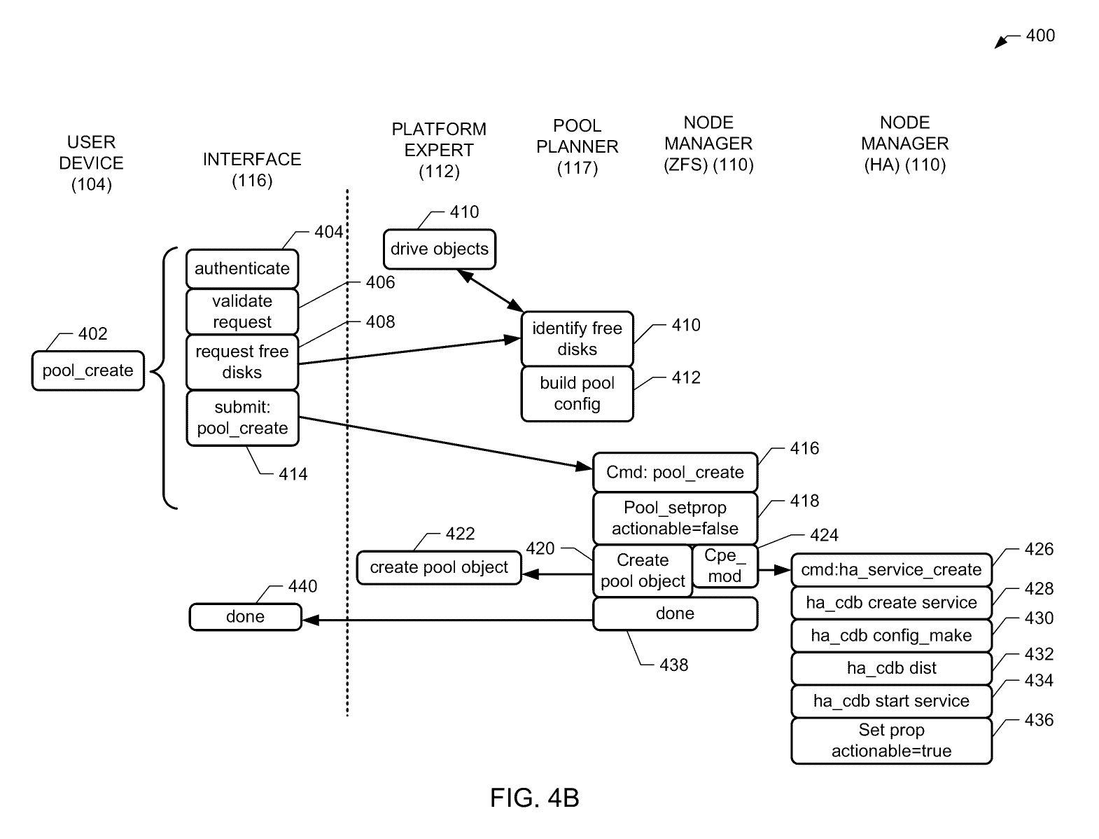

FIGS. 4A, 4B, 5, 6, and 7 illustrate flow diagrams showing example procedures 400, 500, 600, and 700 to create, destroy, and import a storage service using the example node manager 110 and/or the platform expert 112 of FIGS. 1 to 3, according to example embodiments of the present disclosure. Although the procedures 400, 500, 600, and 700 are described with reference to the flow diagrams illustrated in FIGS. 4A, 4B, 5, 6, and 7, it should be appreciated that other approaches to create, destroy, and import a storage service are contemplated by the present disclosure. For example, the order of many of the blocks may be changed, certain blocks may be combined with other blocks, and many of the blocks described are optional. The example procedures 400, 500, 600, and 700 need not be performed using the example node manager 110 and the platform expert 112, but may be performed by other devices. Further, the actions described in procedures 400, 500, 600, and 700 may be performed among multiple devices including, for example the user device 104, the interfaces 116, 118, 122, and 124, the system events handler 128, the node manager 110, the pool planner 117, the platform expert 112, and more generally, the storage service provider 102 of FIGS. 1 to 3.

FIG. 4A shows a diagram of a procedure 400 to create a storage service (e.g., a service pool). Initially, before (or immediately after) a user requests the service pool, at least a portion of the storage devices 114 of FIG. 1 are determined to be available with at least one storage cluster being configured for use by a user. Additionally, at least one storage node is operational and available for the user. To create the storage service, the user device 104 transmits a pool create command or message to the user interface 116 of the storage service provider 102 (block 402). The example interface 116 (or the REST API 308) is configured to authenticate and validate the pool request (blocks 404 and 406). The interface 116 (using the information from the user) also communicates with the pool planner 117, the platform expert 112, and/or the node manager 110 to determine free/available space on the storage devices 114 (blocks 408, 409, and 410). The pool planner 117 may also be configured to create or build a configuration for the storage pool, which may be stored to the resource data structure 119 (block 412). It should be appreciated that the user, via the user device 104, specifies the configuration resources, parameters, properties, and/or objects for the storage service using the interface 116. The interface 116 also submits an instruction or command including the configurations to the node manager 110 to create the storage pool (block 414). The code below shows an example storage pool creation commend.

{

“command”: “pool_create”,
“version”: “1.0”,
“type”: “request”,
“parameters”: {

“attributes”: {

“alias”: “”,
“kind”: “PHYSICAL”,
“aoe_pool_num”: 42,
“intent”: “BLOCK”
},

“config”: [
{

“redundancy”: “RAIDZ2”,
“drives”: [
“a38220a7-bfef-5fdc-bfd1-9e887b585f66”,
“04a2a3ff-e13b-505a-8996-4f114f7dbe38”,
“25b755ac-f669-52cb-bda4-5db346be61b6”,
“d8fc75d6-b92a-5757-8f86-4b7826fac864”,
“a0441297-e9d8-5f5c-8a92-be5f1cddd2bb”,
“8cfaaa33-3886-577f-802d-1096dbca68dd”,
“698e3af7-a811-53f0-af6d-280637cf5be1”,
“e61051d6-3ef3-5cba-abdf-6753c4c8018d”,
“8bae596b-4083-5156-a98e-c9e91f43c6ce”
]

},
{

“redundancy”: “RAIDZ2”,
“drives”: [
“721080fc-f024-5a28-a172-d6c2e25685a5”,
“3a8eb214-2874-5d0f-99bc-6e161ec56998”,
“9c2e3e88-5b51-592c-88d2-61c3b8257fd3”,
“88849795-dfc8-5c79-b265-9adac1f3e6b5”,
“c763c71d-711b-55f4-bf4f-c216ad1dd0ae”,
“e6e8edf0-6005-5991-aab6-c0292b278360”,
“f868c239-97d1-594b-b154-a28e707d2000”,
“a7b99135-f36e-555a-b811-b5ba416e09d9”,
“f254b626-9608-5ace-86de-be79c4befa10”
]

}
]

}

}

The example node manager 110 is configured to translate the above command with the configurations of the storage pool to a sequence of storage functions (e.g., ZFS functions) and system calls that create or provision the storage pool/service among the storage devices 114. For instance, a ZFS component or application within the node manager 110 (or accessed externally at a third-party provider) receives the storage pool create command and auto-imports the storage pool (e.g., makes the storage pool available and/or accessible on at least one node) (blocks 416 and 418). The ZFS component also generates a pool-import event to advertise the coming online of the new storage resources located within or hosted by the storage devices 114 (block 420). The system event handler 128 is configured to detect the advertisement and send a message to the platform expert 112 indicative of the coming online of the new storage pool. The advertisement may include a UUID of the storage pool. In response, the platform expert 112 creates a graphical representation of the storage pool including resources and/or objects of the pool by calling or accessing the node manager 110 using the UUID of the storage pool to determine or otherwise obtain attributes, properties, objects of the newly created storage pool (block 422).

The example ZFS component of the node manager 110 is also configured to transmit a command to a HA component of the node manager 110 to further configure and/or create the storage pool (block 424). In response to receiving the command, the HA component creates the HA aspects or functions for the storage pool including the initialization of the storage pool service (blocks 426 to 436). It should be appreciated that ‘ha_cdb’ refers to a high availability cluster database. In some embodiments, the ‘ha_cdb’ may be implemented using a RSF-1 failover cluster. The node manager 110 transmits a completion message to the user device 104 (or the interface 116) after determining that the storage pool has been configured and made available to the user (blocks 438 and 440). At this point, the storage pool has been created, cluster service for the storage pool has been created, and all cluster storage nodes are made aware of the newly created storage pool.

FIG. 4A shows that the node manager 110 asynchronously updates the CPE (block 424) and generates the pool-import event (block 420) to cause the platform export 112 to create the graphical representation of the storage pool. In another embodiment, as shown in FIG. 4B, the node manager 110 is configured to update the CPE (block 424) inline with generating the pool-import event (block 420). Such a configuration may ensure that the graphical representation of the storage pool is created at about the same instance that the CPE is updated.

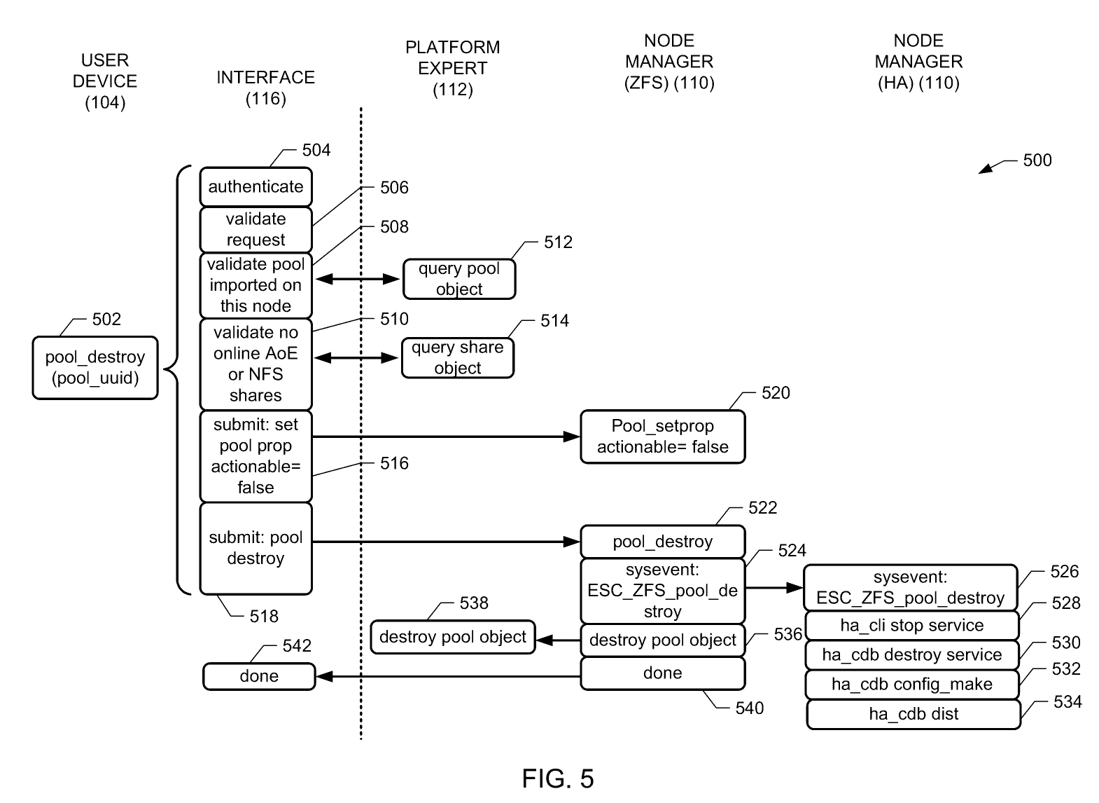

FIG. 5 shows a diagram of a procedure 500 to destroy or decommission a storage service. To begin the procedure 500, the user device 104 transmits a pool destroy command or message to the interface 116 of the storage service provider 102 (block 502). The command may include a UUID of the storage service or storage pool. The example interface 116 is configured to authenticate and validate the command or request message (blocks 504 and 506). The interface 116 also validates that the requested service pool is on a specified node and that there are no online AoE or NFS shares with other nodes (blocks 508 and 510). This includes the interface 116 accessing the platform expert 112 to query one or more storage pool objects and/or storage share objects within a graphical representation of the requested storage pool (blocks 512 and 514). Alternatively, the interface 116 may query a configuration file, specification, or resource associated with the requested storage pool located within the resource data structure 119. The example interface 116 then transmits commands to the ZFS component of the node manager 110 to destroy the specified service pool (blocks 516 and 518).

The example node manager 110 uses, for example, a ZFS component and/or an HA component to deactivate and destroy the storage pool (blocks 522 to 530). The node manager 110 also uses the HA component to make recently vacated space on the storage devices 114 available for another storage pool or other storage service (blocks 532 and 534). Further, the node manager 110 transmits a destroy pool object message to the platform expert 112, which causes the platform expert 112 to remove or delete the graphical representation associated with the storage pool including underlying storage resources, objects, parameters, etc. (blocks 536 and 538). The node manager 110 transmits a completion message to the user device 104 (or the interface 116) after determining that the storage pool has been destroyed (blocks 540 and 542).

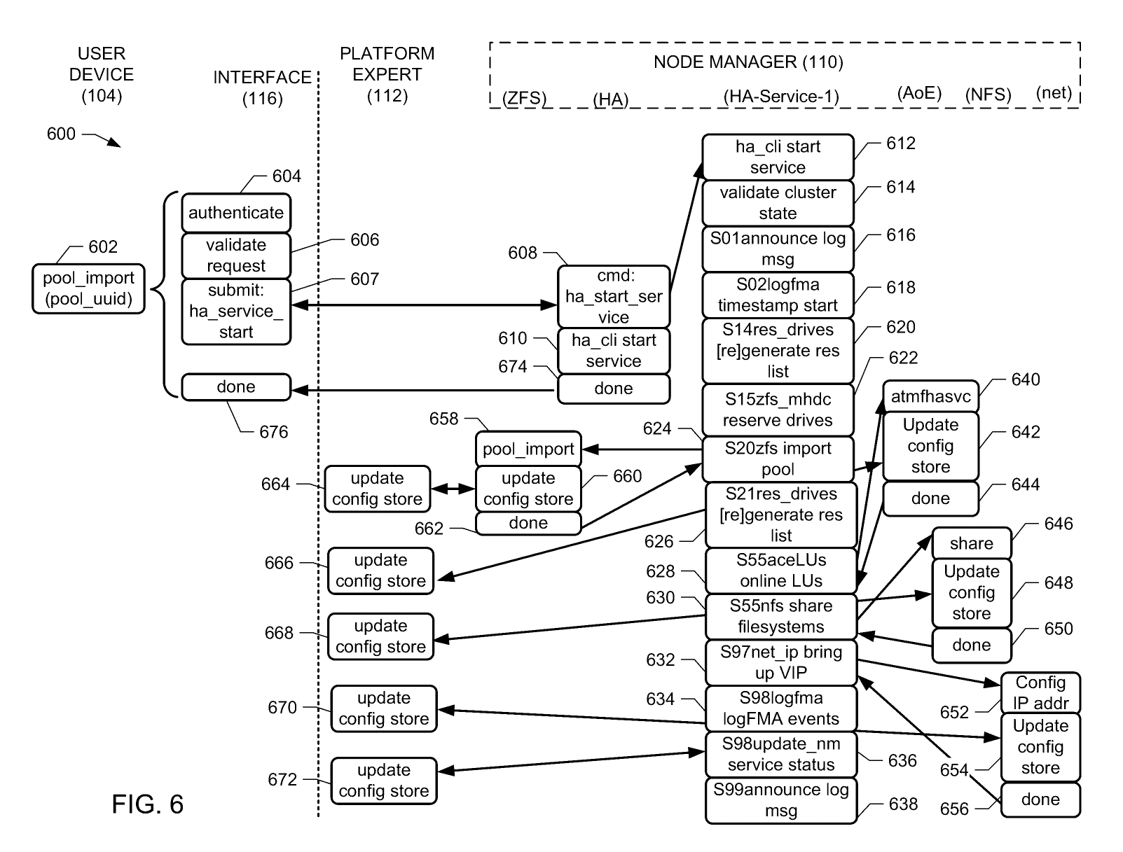

FIG. 6 shows a diagram of a procedure 600 to import a storage service. To begin the procedure 600, the user device 104 transmits a command or a request to import a storage service (e.g., a storage pool) (block 602). The request may include a UUID of the storage pool. The example interface 116 is configured to authenticate and validate the command or request message (blocks 604 and 606). The interface 116 also transmits a command or message to a HA component of the node manager 110 to begin service for the service pool to be imported (blocks 607, 608, and 610). A high availability service-1 component (e.g., a RSF-1 component) of the node manager 110 is configured to manage the importation of the service pool including the updating of clusters and nodes, reservation of disk space on the storage devices 114, assignment of logical units and addresses, and the sharing of a file system (blocks 612 to 638). The high availability service-1 component may invoke or call an AoE component for the assignment of logical units to allocated portions of the storage devices 114 (blocks 640 to 644), the NFS component to configure a file system (blocks 646 to 650), the NET component to configure an IP address for the imported storage pool (blocks 652 to 656), and the ZFS component to import data and configuration settings for the storage pool (blocks 658 to 662). The ZFS, high availability service-1, AoE, NFS, and NET components may transmit messages to update a configuration file at the node manager 110, which is stored to the resource data structure 119. The platform expert 112 is configured to detect these configuration events and accordingly create a graphical representation of the imported storage pool (blocks 664 to 672). The node manager 110 may also transmit a completion message to the user device 104 (or the interface 116) after determining that the storage pool has been imported (blocks 674 and 676).

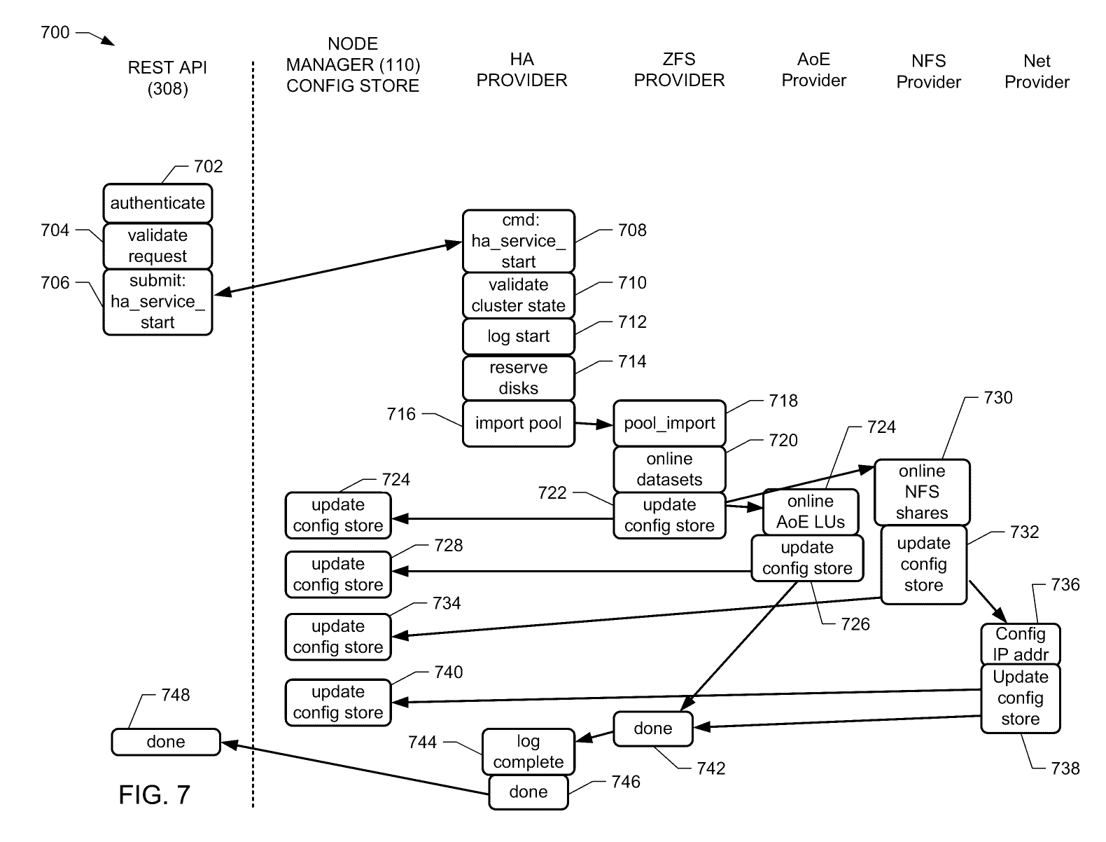

FIG. 7 shows a diagram of a procedure 700 to import a storage service according to another embodiment. The procedure 700 begins when the REST API 308 (and/or the interface 116) receives a request to import a storage service (e.g., a storage pool). The request may include a UUID of the storage pool. The example REST API 308 is configured to authenticate and validate the request message (blocks 702 and 704). The REST API 308 also transmits a command or message to a HA component of the node manager 110 (or the HA provider 106a) to begin service for the service pool to be imported (blocks 706 and 708). The HA component is configured to manage the importation of the service pool including the updating of clusters and nodes, management of a log to record the service pool importation, reservation of disk space on the storage devices 114, assignment of logical units and addresses, and/or the sharing of a file system (blocks 710 to 716).

The example HA component calls a ZFS component or provider 106d to import the service pool and bring datasets online (blocks 718 and 720). The ZFS component may invoke or call an AoE component (e.g., an AoE provider 106c) for the assignment of logical units to allocated portions of the storage devices 114 (block724) and an NFS component to configure a file system (block 730). The NFS component may instruct the NET component to configure an IP address for the imported storage pool (block736). The ZFS, HA, AoE, NFS, and NET components may transmit messages to update a configuration file at the node manager 110, which may be stored to the resource data structure 119 (blocks 722, 724, 726, 728, 732, 734, 738, 740). After the service pool is imported, the HA component ends the log and sends one or more messages to the node manage 110 and the REST API 308 indicating that the service pool has been imported (blocks 742 to 748). While not shown, the platform expert 112 may be configured to detect these configuration events and create a graphical representation of the imported storage pool.

### Pool Planner Embodiments

As discussed above, the storage devices 114 of FIG. 1 may include tens to thousands of devices. The storage devices 114 may include storage drives, storage disks, physical blocks, virtual blocks, physical files, virtual files, and memory devices including at least one of HDDs, SSDs, AoE Logical Units, SAN Logical Units, ramdisk, and file-based storage devices. The storage devices 114 may be arranged in physical storage pools with one or more physical storage nodes, each having at least one redundant physical storage group. The addressing and/or identification of the storage devices 114 may be virtualized for higher-level nodes.

The example node manager 110 in conjunction with the pool planner 117 is configured to select devices 114 for provisioning in a storage pool based on criteria, storage requirement information, specifications, SLAs, etc. provided by a third-party. The node manager 110 is configured to receive and process the criteria from the third-party for the pool planner 117, which is configured to select the devices 114 (or objects, and/or other resources) based on the provided information. The example node manager 110 configures a storage pool using the devices 114 selected by the pool planner 117. It should be appreciated that the node manager 110 and the pool planner 117 may be separate processors, servers, etc. Alternatively, the node manager 110 and/or the pool planner 117 may be included within the same server and/or processor. For instance, the pool planner 117 and the node manager 110 may be virtual processors operating on the same processor.

It should be appreciated that determining available devices from among the tens to thousands devices 114 is a virtually impossible task for a system expert or administrator. During any given time period between system snapshots, the availability of devices may change (due to migrations or expansions of current storage systems), which makes determining devices for a new storage service extremely difficult when there are many devices to track. Moreover, determining which of the thousands of devices 114 are best for pools, logs, caches, etc. is also extremely difficult without one or more specifically configured algorithms. Otherwise, an administrator and/or system expert has to individually compare the capabilities of a device to client or third-party requirements and manufacturer/industry recommendations.

Some known storage system providers determine an optimal storage pool configuration for certain hardware platforms. This solution works well when the physical hardware or devices 114 are known in advance and the configuration (and number) of hardware or devices will not change. Other known storage system providers use an out-of-band API to communicate data storage configuration information to administrators or system experts to assist in identifying redundancy or performance capabilities of data-stores. However, this information is still reviewed and acted upon manually by the administrators and system experts whom painstakingly select, configure, modify, and provision each device for a storage pool.

The example pool planner 117 in conjunction with the node manager 110 of FIGS. 1 and 3 are configured to address at least some of the above known issues of manually provisioning a storage service by using one or more filters to automatically determine storage devices for a requested storage pool. Each of the filters may be specifically configured based on storage requirement information provided by a requesting third-party. Such an automated configuration reduces costly pool configuration mistakes by removing manual steps performed by administrators and/or system experts. The filter(s) and algorithm(s) used by the pool planner 117 and/or the node manager 110 may implement one or more best practices for reliability, availability, and/or serviceability (“RAS”). This also enables a more simplified REST layer to implement the best practices and policies.

The disclosed automated configuration further provides simplified management of cloud-scale storage environments or storage systems with less table-of-contents (“TOC”) with respect to specialized subject matter expert (“SME”) resources. The disclosed configuration of the pool planner 117 and the node manager 110 also enables provisioning at scale, thereby making pool configuration repeatable and less error prone. It should also be appreciated that the disclosed configuration provides maximum flexibility at the node manager layer with respect to provisioning, modifying, or expanding storage pool devices and/or resources.

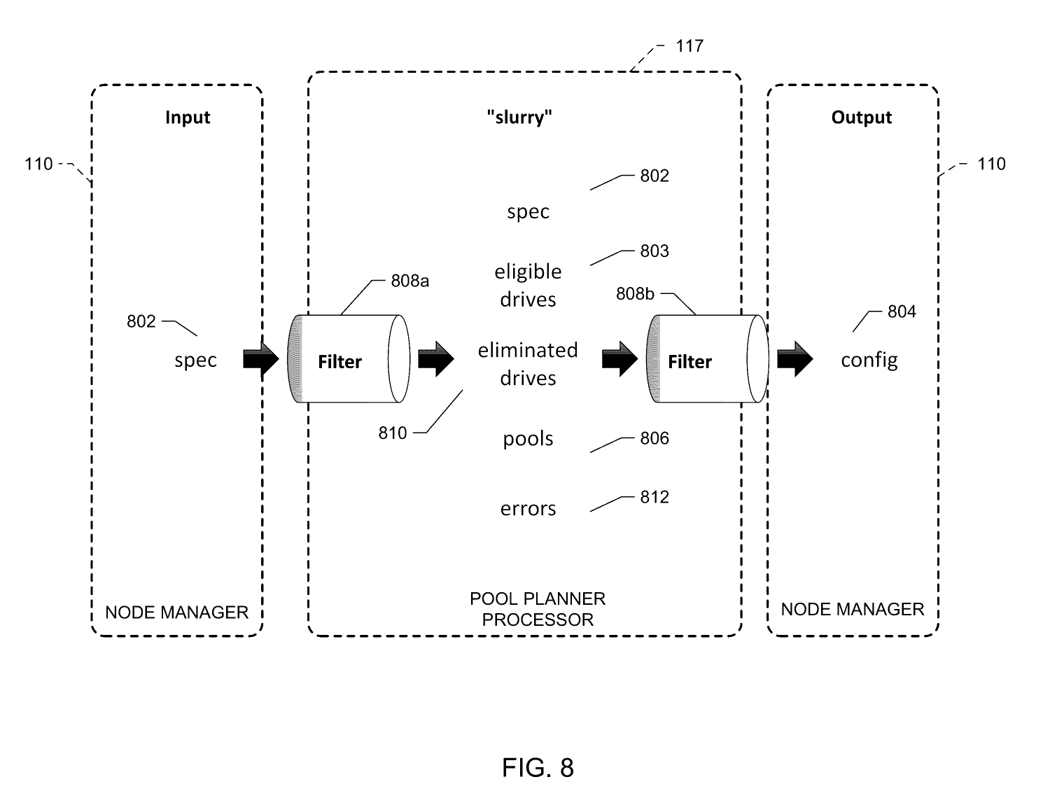

FIG. 8 shows a diagram of an example relationship between the pool planner 117 and the node manage 110 for creating a storage pool of drives (e.g., the devices 114 of FIG. 1), according to an example embodiment of the present disclosure. The example node manager 110 is configured to receive an input (e.g., ‘spec’) 802 that includes storage requirement information provided by a third-party, client, user, etc. The storage requirement information may be provided in any format and include any information useful for provisioning a storage pool. In particular, the storage requirement information may include properties, attributes, values, properties, information, etc. including an indication of a physical storage pool or a virtual storage pool, intent information (e.g., file or block), redundancy information, a number of devices or drives desired, a media type, a physical redundancy type, a minimum revolutions per minute (“RPM”) for the devices, a minimum drive or device size, a like drive or device indication, an AoE pool number (or multiple AoE pool numbers), product name, and/or a vendor name. It should be appreciated that the node manager 110 in some instances may require a third-party to provide certain storage requirement information before a storage pool may be created. In other instances, the node manager 110 may select or fill in information not provided by the third-party to enable the storage pool to be created. For instance, best practices or reliance on the other storage requirement information may be used to determine other storage requirement information not provided by a third-party. In yet other instances, the node manager 110 may indicate that missing information is provided a ‘null’ value such that the corresponding parameter or property is not considered or configured in a filter during determination and selection by the pool planner 117.

The example node manager 110 may convert the storage requirement information into at least one of an attribute-value pair or JavaScript Object Notation (“JSON”) before transmitting the storage requirement information to the pool planner 117. In other instances, the REST API 308 and/or the JSON API 304 may require a third-party to specify the storage requirement information as a key-value pair or attribute-value pair (e.g., ‘intent=FILE’), and/or JSON (e.g., “intent”:“FILE”). The node manager 110 may also convert strings in the storage requirement information to numbers. In some instances, when called via the node manager 110, JSON parameter objects may be converted to key-value pairs and/or attribute-value pairs. After making any conversions of the storage requirement information, the example node manager 110 transmits the (converted) storage requirement information to the pool planner 117.

The code below shows an example of how the pool planner 117 is configured to accept arguments directly (e.g., via a command lime) via a call named ‘cordclnt’. In this example, the arguments are passes as key-value pairs.

| usage: pool_plan [-h] [-d] [-l] [-m MESSAGE] [-R ROOT] ... | |
|---|---|
| create a plan for zfs_pool_create | |
| positional arguments: | |
| key=value | |
| optional arguments: | |
| -h, --help | show this help message and exit |

| | |
|---|---|
| -d, --debug | show debug messages |

| | |
|---|---|
| -l, --list | list available filters |

-m MESSAGE, --message MESSAGE

start pipeline with message, default is to read from stdin

-R ROOT, --root ROOT choose alternate root (/) directory

The code below shows an example spec 802 received by the pool planner 117 to determine available drives for a storage pool.

object {

object { //input spec

| string drives_per_set; | //int |
|---|---|
| string drives_needed; | //int |
| string kind [“PHYSICAL”, “VIRTUAL”]?; | |
| string redundancy [“NONE”, “MIRROR”, “RAIDZ1”, | |
| “RAIDZ2”, “RAIDZ3”]?; | |
| string min_size?; | // number |
| string max_size?; | // number |

| | |
|---|---|
| boolean ssd?; | |
| string media?; | // regex |
| string role?; | // regex |

| string physical_blocksize?; // regex | |
|---|---|
| string vendor_id?; | // regex |
| string product_id?; | // regex |

| | |
|---|---|
| string rpm?; | // regex |

| string min_rpm?; | // number |
|---|---|
| string pool_uuid?; | // UUID of existing, imported pool |
| | to match |
| string like_drive?; | // UUID of existing drive to match |
| string intent [“BLOCK”, “FILE”]?; // passed through | |
| string name?; | // passed through |

}* spec;
object {

| | |
|---|---|
| string command; | // this program: pool_plan |

| | |
|---|---|
| string message; | // if errors reported: pool plan failed |

array { object {

string filter; // filter stage where error occurred
string message; // human-readable error message

}*;} errors?; // errors reported by this program

| } error?; | |
|---|---|
| array { object { }*;} drives?; | // object = drive devnode.json + |

type conversions
array { object { }*;} eliminated?; // object = drive devnode.json +

type conversions + reason

array {

object {

string redundancy [“NONE”, “MIRROR”, “RAIDZ1”,
“RAIDZ2”, “RAIDZ3”];
array { string } drives?; // drive UUID

};

} config?;

}*

The example pool planner 117 (e.g., a ZFS pool planner) is configured to use the received storage requirement information (e.g., the spec 802) to determine which of the devices 114 (e.g., disks, drives, etc. of eligible devices 803) are to be provisioned for a storage pool. The received storage requirement information includes at least a minimum amount of information for the pool planner 117 to determine devices. The minimum amount of information may include a number of devices and a redundancy required by the third-party. The pool planner 117 is configured to output a configuration (e.g., ‘config’) 804 including identifiers of determined storage devices, which is used by the node manager 110 in, for example, a ZFS pool_create command, to provision a storage pool. The example pool planner 117 may be configured as part of a REST API pool creation task of the storage service provider 102 of FIGS. 1 and 3.

The code below shows an example config 804 provided by the pool planner 117 based on operating the spec 802 through one or more filters 808.

object {

object {

string kind [“PHYSICAL”, “VIRTUAL”]?;
string intent [“BLOCK”, “FILE”]?;
string name?;
string aoe_pool_num?;

} attributes?;
array {

object {

string redundancy [“NONE”, “MIRROR”, “RAIDZ1”,
“RAIDZ2”, “RAIDZ3”];
array { string } drives?; // drive UUID

};

} config?;
// the following objects only exist if errors detected
object {

| | |
|---|---|
| string command; | // this program: pool_plan |

| | |
|---|---|
| string message; | // if errors reported: pool plan failed |

array { object {

string filter; // filter stage where error occurred
string message; // human-readable error message

| | |
|---|---|
| }*;} errors?; | // errors reported by this program |

| } error?; | |
|---|---|
| array { object { }*;} drives <errors>; | // object = drive |

devnode.json
array { object { }*;} eliminated <errors>; // object = drive
devnode.json

}*

To determine devices for a storage pool 806, the example pool planner 117 of FIG. 8 is configured to use the storage requirement information to determine, as the eligible storage devices 803, storage devices 114 within a storage system that have availability to be placed into the storage pool 806. The eligible storage devices 803 may include the storage devices 114 with at least a portion of open disk space or a drive that is not being used. The example pool planner 117 then uses one or more filters 808 to eliminate the eligible or available storage devices 803 (shown as eliminated drives 810). The filters 808 are applied in series so that devices eliminated by a first filter are not considered by a subsequent filter. For instance, the pool planner 117 applies a first filter 808a to the available storage devices 803 to eliminate a first set 810 of the available storage devices and determine remaining storage devices. Then, the pool planner 117 applies a second filter 808b to the remaining storage devices after the first filter 808a to eliminate a second set 810 of the remaining storage devices. If only the two filters 808 are specified to be used, the pool planner 117 then designates the storage devices remaining after second filter as identified storage devices within one or more pools 806. It should be appreciated that the modular architecture of the pool planner 117 in conjunction with the filters 808 enables new filters to be added and/or current filters to be modified based on system maturity and/or feedback.

If one of the filters eliminates a drive, the drive will no longer be checked by any subsequent downstream filters. In some instances, the example pool planner 117 may compile a list or other data structure that includes identifiers of the eliminated drives 810. The file may include a name of the filter 808 that eliminated the drive in conjunction with the term ‘eliminated by’. The file entry for each eliminated drive may also include a string (adjacent to the filter name) added by the filter that eliminated the drive that is indicative as to why the drive was filtered. The sting may include, for example, ‘check_media: media is not hdd’, ‘actionables: actionable flag !=yes’, and ‘in_local_pool: in use by local pool 2d774bc1-24c4-5252-b4d9-6ef586e38b2’.

In some instances, a conflicting set of filter parameters are set, thereby resulting in an eligible drive list that is empty. For example, a filter spec of ‘vendor_id=SEAGATE’ and ‘product_id=ZeusRAM’ produces an empty set of eligible drives because the Seagate company does not sell a product with the name ‘ZeusRAM’.

It should be appreciated that the first filter 808a includes a first portion of the storage requirement information (e.g., a attribute-pair of information) and the second filter 808b includes a second different portion of the storage requirement information. In some embodiments, the first filter and the second filter (any other filters) may be combined into a single filter such that the filtering process is only executed once.

In conjunction (or alternative to) the eliminated drives 810, the pool planner 117 may create a list of errors 812, indicative of a situation where one of the filters 808 detects a condition where a viable pool of devices 806 meets the spec 802 but cannot be created. In other instances, the pool planner 117 may generate an error when not enough or even one device cannot be located to satisfy storage requirement information and/or the specs 802. Once an error for a pool of drives has been detected by the pool planner 117 and/or a filter 808, each subsequent filter will not work for the same pool of drives, but the subsequent filter may check for additional errors for the pool of drives. Thus any error in the filter chain gets propagated and ultimately reported back to a user or system caller. In the event of a failure, the example pool planner 117 is configured to create a list of errors 812 that includes, for example, an interpretation of storage requirement information and/or the specs 802. The list 812 and/or the spec 802 may also contain a state of currently known devices or objects (e.g., CPE objects) that impacted the decision of the respective filters 808. The list 812 may also identify remaining eligible drives 803 (as listed in a drives array) and the eliminated drives 810 (as listed in an eliminated drives array). An example of code that may be executed by the pool planner 117 when an error is detected is shown below.

// this object only exists if errors detected
object {

| | |
|---|---|
| string command; | // this program: pool_plan |

| | |
|---|---|
| string message; | // if errors reported: pool plan failed |

```
array { object {
  string filter; // filter stage where error occurred
  string message; // human-readable error message
```

| | |
|---|---|
| }*;} errors?; | // errors reported by this program |

} error?;

In some embodiments, the pool planner 117 and/or the node manager 110 of FIGS. 1 to 3 and 8 may be configured to provide debug information to a user. For instance, a user may select to view debug information before and/or after a pool of drives is created. In other instances, the pool planner 117 and/or the node manager 110 may create debug information after one or more errors are detected. The debug information may describe actions performed by the filters to eliminate drives, internal status information, storage requirement information, pool configurations from a local node, audit information, the specs 802, and/or current state information. The code below may be executed by the pool planner 117 and/or the node manager 110 to determine why drives were eliminated.

pool_plan debug=true kind=PHYSICAL intent=BLOCK
drives_needed=1
drives_per_set=1 redundancy=NONE aoe_pool_num=73| json
eliminated | json -ag uuid eliminated_by

### I. Filter Embodiments

In some embodiments and/or instances, the filters 808 of FIG. 8 may be configured to read data from drivers and/or I/O to determine if the drive meets the criteria of the filter 808. For example, the following filters may be programmed to read data from drives ‘check reservation’ or ‘check_existing_fs’. Reading data from drivers and/or I/O can be time consuming, especially if there are thousands to millions of drives. The example pool planner 117 of FIGS. 1 to 3 and 8 is configured to accordingly apply the filters 808 such that the most drives and/or pools of drives are eliminated first. Such a configuration of the filters 808 reduces processing time for downstream filters since more (or most) of the eligible drives 803 are eliminated by the first filter 808a. Alternatively, the pool planner 117 may be configured to pass over reading from eligible drives for one or more filters, such as for example, one or more initial filters configured to eliminate a significant number of eligible drives.

Examples of filters 808 are provided in Table 1 below, with each filter having a unique name and input. Some of the filters 808 have an output and are configured to eliminate one or more drives. The description field provides a description for the procedure performed by the respective filter 808. Collectively, the filters 808 may be categorized as a filter configured to (i) collect and/or determine specs (e.g., the ‘spec_from_arg_kV’ filter), (ii) set global conditions and/or discover drives and pools (e.g., the eligible drivers 803) (e.g., the ‘find_drives’ and ‘find_local_pools’ filters), (iii) eliminate drives that do not match an input or specified criteria (e.g., the ‘virtual_pool’ filter), and (iv) create a pool configuration (e.g., the ‘build_config’ filter).

Some of the filters shown below in Table 1 (e.g., the ‘product_id’ filter, the ‘vendor_id’ filter, and the ‘rpm’ filter) are configured to check values against regular expressions (e.g., python regular expressions). Other filters (e.g., the ‘min_rpm’ filter) shown below are configured to check against numbers using a key-value pair or JSON value. The filter and/or the pool planner 117 may convert strings to floating values. It should be appreciated that some filters may output a value for the spec 802 if no spec exists and/or to validate a value in the spec 802. It should also be appreciated that other embodiments may include additional or fewer filters.

TABLE 1
Filter Examples

| Name | Input | Output | Eliminates | Description |
|---|---|---|---|---|
| spec_from_arg_kv | key = value pairs | spec | — | Reads spec from key = value pairs |
| | as command line | | | Primarily intended to be used by |
| | arguments | | | cordadmd using the pool planner |
| | | | | as a trusted script |
| spec_from_arg | JSON spec | spec | — | If no spec is yet found, reads |
| | | | | JSON spec as the arguments |
| | | | | from the -m command line option. |
| | | | | This JSON spec is the same as if |
| | | | | pool_plan is called from cordclnt. |
| spec_from_stdin | JSON spec | spec | — | If no spec is yet found, reads |
| | | | | JSON from stdin |
| spec_to_defaults | spec | — | — | Assigns internal defaults from the |
| | | | | current spec. These defaults can |
| | | | | override the internal defaults for: |
| | | | | debug |
| | | | | read_from_drive |
| | | | | append_to |
| validate_initial_spec | spec | — | — | Initial spec validation. This |
| | | | | includes spec items that can be |
| | | | | tested prior to examining the |
| | | | | platform's configuration |
| single_node_cluster | — | — | — | Checks to see if node is running |
| | | | | as a single-node cluster. This |
| | | | | knowledge is used by later filters. |
| find_drives | Platform Expert's | eligible | — | Finds all of the drives seen by the |
| | drive | drives | | node |
| | configuration | | | |
| find_local_pools | Platform Expert's | pools | — | Finds all of the pools currently |
| | local pool | | | imported by the node |
| | configuration | | | |
| spec_like_drive | like_drive | — | — | If a drive matching UUID is |
| | | | | found, then the filter spec is |
| | | | | adjusted to include the features |
| | | | | of the spec_like drive. Features |
| | | | | added to the spec from the |
| | | | | like_driver are: |
| | | | | vendor_id |
| | | | | product_id |
| | | | | size |
| | | | | media |
| | | | | interface_type |
| | | | | physical_blocksize |
| | | | | role |
| | | | | rpm |
| spec_from_pool_uuid | pool_uuid | — | — | If a pool matching UUID is found, |
| | | | | then the output is to be used for |
| | | | | pool expansion rather than pool |
| | | | | creation. The spec settings |
| | | | | depend on the append_to |
| | | | | parameter (default = pool) thusly: |
| | | | | kind |
| | | | | intent |
| | | | | aoe_pool_num[s] |
| | | | | append_to = pool |
| | | | | prefer large drives over small |
| | | | | drives |
| | | | | drives_per_set |
| | | | | if not specified, |
| | | | | drives_needed = drives_per_set |
| | | | | media |
| | | | | interface_type |
| | | | | role |
| | | | | physical_blocksize |
| | | | | rpm |
| | | | | append_to = log |
| | | | | prefer small drives over large |
| | | | | drives |
| | | | | media = ssd or ram |
| | | | | if not specified, |
| | | | | drives_per_set = 2 |
| | | | | if not specified, redundancy = |
| | | | | MIRROR |
| | | | | if not specified, |
| | | | | drives_needed = 2 |
| | | | | append_to = cache |
| | | | | prefer large drives over small |
| | | | | drives |
| | | | | media = ssd or ram |
| | | | | drives_per_set = 1 |
| | | | | redundancy = NONE |
| | | | | if not specified, |
| | | | | drives_needed = 1 |
| validate_spec | spec | — | — | Final spec validation prior to |
| | | | | filtering. |
| actionables | actionable | eligible | actionable != yes | Eliminate drives that are not |
| | | drives | | actionable |
| virtual_pool | kind | eligible | kind == VIRTUAL and | Eliminates drives not suitable for |
| | | drives | interface_type != aoe | virtual pools |
| physical_pool | kind | eligible | kind == PHYSICAL | Eliminates drives not suitable for |
| | | drives | and interface_type == | physical pools |
| | | | aoe | |
| check_vendor_id | optional | eligible | if vendor_id in spec, | Filter on vendor_id |
| | vendor_id | drives | vendor_id | |
| | | | mismatches | |
| check_product_id | optional | eligible | if product_id in spec, | Filter on product_id |
| | product_id | drives | product_id | |
| | | | mismatches | |
| check_media | optional media | eligible | if media in spec, | Filter on media |
| | | drives | media mismatches | |
| check_backing_redundancy | optional | eligible | if | Filter on backing_redundancy |
| | backing_redundancy | drives | backing_redundancy | |
| | | | in spec, | |
| | | | backing_redundancy | |
| | | | mismatches | |
| check_ssd | optional ssd | eligible | if ssd in spec, ssd | Deprecating from PXE, use |
| | | drives | mismatches | media instead |
| check_role | optional role | eligible | if role in spec, role | Filter on role |
| | | drives | mismatches | |
| check_physical_block | optional | eligible | if physical_blocksize | Filter on physical_blocksize |
| size | physical_blocksize | drives | in spec, | |
| | | | physical_blocksize | |
| | | | mismatches | |
| check_rpm | optional rpm | eligible | if rpm not equal to | Filter on rpm |
| | | drives | spec | |
| check_aoe_pool_num | optional array of | eligible | if kind = VIRTUAL, | Filter on AoE pool number |
| | AoE pool | drives | eliminate drives that | |
| | numbers | | are are not in the | |
| | | | aoe_pool_nums list | |
| shared_or_unshared | — | eligible | if multinode cluster, | Filter non-shared drives from |
| | | drives | disks with | multinode clusters |
| | | | interface_type != sas | |
| | | | or aoe | |
| in_local_pool | Platform Expert's | eligible | drives already used | Filter drives already in use in |
| | imported pool | drives | by locally imported | local pool |
| | configuration | | pool | |
| check_aoe_target_local | Platform Expert's | eligible | AoE drives that are | Filter drives served from the |
| | imported pool | drives | served from a | same node |
| | configuration | | currently imported, | |
| | | | local pool | |
| min_size | optional min_size | eligible | if min_size in spec, | Filter drives below a minimum |
| | | drives | drives smaller than | size spec |
| | | | min_size | |
| min_rpm | optional min_rpm | eligible | if min_rpm in spec, | Filter drives below a minimum |
| | | drives | drives with rpm less | rpm spec |
| | | | than min_rpm | |
| check_backing_redundancy_group | — | eligible | if kind == VIRTUAL | Ensures virtual pools with no |
| | | drives | and | redundancy will not use |
| | | | redundancy == NONE, | heterogenous |
| | | | drives grouped by | backing_redundancy |
| | | | backing_redundancy | |
| | | | where the size of the | |
| | | | group is less than | |
| | | | drives_needed | |
| check_reservation | if | eligible | eliminates drives that | Checks for SCSI-2 or SCSI-3 |
| | read_from_drive = | drives | are reserved by | (PGR) reservations on the drives |
| | True (default) | | another node | |
| check_existing_fs | if | eligible | eliminates drives that | Checks using the equivalent test |
| | read_from_drive = | drives | appear to have a | of fstyp(1 m) |
| | True (default) | | filesystem already on | Note: only s0, p0, p1, p2, p3, and |
| | | | them | p4 are checked - all other slices |
| | | | | are ignored |
| check_size_tolerance | drives_needed | eligible | drives smaller than | Ensure all drives proposed for |
| | | drives | the tolerance | pool are sized within tolerance |
| | | | (64MiB) | |
| | | | population of drives | |
| | | | smaller than the | |
| | | | minimum sized | |
| | | | group where size is | |
| | | | within tolerance | |
| | | | (64MiB) and the | |
| | | | group size >= | |
| | | | drives_needed | |
| check_backing_redundancy_preferred | — | eligible | if kind == VIRTUAL | Ensure best backing_redundancy |
| | | drives | and | for virtual pools when |
| | | | redundancy == NONE, | redundancy == NONE |
| | | | drives grouped by | |
| | | | backing_redundancy | |
| | | | with the least | |
| | | | redundancy | |
| drives_needed | drives_needed | — | is remaining | If after all of this filtering, is there |
| | | | population >= | enough drives remaining to meet |
| | | | drives_needed | the drives_needed spec? If not, |
| | | | | then error (and do not build pool) |
| build_config | eligible drives, | config | — | Build pool configuration |
| | redundancy, | object | | |
| | drives_per_set, | | | |
| | drives_needed | | | |
| build_attributes | — | attributes | — | Copy values from spec into |
| | | object | | attributes for zpool_create |

### II. Configuration Build Embodiments

After the pool planner 117 determines which drives (e.g., the devices 114 of FIG. 1) are eligible for a storage pool (e.g., a final list of eligible drives), the example node manager 110 (and/or the pool planner 117) is configured to create or build a storage service with one or more of the identified drives. The node manager 110 uses the config 804 from the pool planner 117 in addition to the spec 802 to configure the drives within a storage pool. The node manager 110 determines a layout for the pool using spec parameters including for example, a total number of drives needed and/or requested, a number of drives per top-level set or development, and/or a redundancy (e.g., none, RAID, Mirror, etc.). The spec parameters may be validated during the filter process executed by the pool planner 117, with the validation being provided in the config 804. Additionally, the node manager 110 may determine internal parameters including, for example, a size sort order (e.g., small-to-large (log) or large-to-small (cache and pool)) or a drive's device path.

In some examples, the node manager 110 is configured to create a storage pool to improve, optimize and/or maximize path diversity among the drives. The node manager 110 may use one or more filters and/or algorithms/routines to determine a desired path diversity. Some systems may not have path diversity for serial-attached SCSI (“SAS”) ports within a single canister. Accordingly, a HA cluster may be used to create path diversity through canister diversity and/or diversity within each canister. In comparison, AoE path diversity may be based on the AoE pool number.

To create diversity among the eligible drives, the example node manager 110 is configured to determine a path to each drive. AoE drives may be sorted by pool number while other drives are sorted by the device path. For CorOS 8.0.0, device_path for devices that use mpxio multipathing are not grouped by their multiple paths. Instead, all of the devices treated as one group, which is a reasonable decision for EX and ZX hardware.

The node manager 110 then builds a table (or list, data structure, etc.) using the device path in a column next to the respective drive name. For example, the pool planner 117 may provide to the node manage 117 a list of 16 eligible drives, shown below in Table 2 by the drive name. The node manager 110 determines an AoE pool number for each drive and add that information to the table. The node manager 110 may then add drives as rows for each respective device path. For example, all drives with the same 100 AoE pool number are placed within the ‘100’ column, shown in Table 3.

TABLE 2
Example Drive Build Table

| Drive | aoe_pool_num |
|---|---|
| drive1 | 100 |
| drive2 | 100 |
| drive3 | 224 |
| drive4 | 392 |
| drive5 | 392 |
| drive6 | 100 |
| drive7 | 100 |
| drive8 | 224 |
| drive9 | 100 |
| drive10 | 392 |
| drive11 | 100 |
| drive12 | 224 |
| drive13 | 100 |
| drive14 | 392 |
| drive15 | 100 |
| drive16 | 224 |

TABLE 3
Example Drive Assignment

| Path | 100 | 224 | 392 |
|---|---|---|---|
| Row1 | drive1 | drive3 | drive4 |
| Row2 | drive2 | drive8 | drive5 |
| Row3 | drive6 | drive12 | drive10 |
| Row4 | drive7 | drive16 | drive14 |
| Row5 | drive9 | | |
| Row6 | drive11 | | |
| Row7 | drive13 | | |
| Row8 | drive15 | | |

The example node manager 110 is configured to build the pool drives by going through each path list, round-robin, and select a drive from each list until the number of drives needed and/or specified has been reached. The node manager 110 creates the pools such that each top-level set contains only the specified number of drives per set. Table 4 below shows different examples of how the 16 drives may be configured based on the drives needed, drives per set, and redundancy. It should be appreciated that this described algorithm or drive filtering provides arguably the best diversity among drives as possible by spreading wide, then deep the assignment of drives across all diverse paths.

In an example from Table 4 below, a configuration with six needed drives, two drives per set, and mirror redundancy results in three sets of two drives each such that each set is a mirror of each other. To increase path diversity, the node manager 110 is configured to progress across the first row of Table 3 to select the two drives (i.e., drive1 and drive3) for the first set and the first drive for the second set (i.e., drive4). The node manager 110 is configured to progress to the second row of Table 3 to select the other drive for the second set and the two drives (i.e., drive8 and drive5) for the third set.

TABLE 4
Examples of Drive Pools

| drives_needed | drives_per_set | redundancy | zpool create CLI pool config |
|---|---|---|---|
| 1 | 1 | NONE | drive1 |
| 4 | 1 | NONE | drive1 drive3 drive4 drive2 |
| 16 | 1 | NONE | drive1 drive3 drive4 drive2 drive8 drive5 drive6 drive12 |
| | | | drive10 drive7 drive16 drive14 drive9 drive11 drive13 |
| | | | drive15 |
| 6 | 2 | MIRROR | mirror drive1 drive3 |
| | | | mirror drive4 drive2 |
| | | | mirror drive8 drive5 |
| 6 | 3 | MIRROR | mirror drive1 drive3 drive4 |
| | | | mirror drive2 drive8 drive5 |
| 6 | 6 | RAIDZ1 | raidz1 drive1 drive3 drive4 drive2 drive8 drive5 |
| 6 | 6 | RAIDZ2 | raidz2 drive1 drive3 drive4 drive2 drive8 drive5 |
| 12 | 6 | RAIDZ2 | raidz2 drive1 drive3 drive4 drive2 drive8 drive5 |
| | | | raidz2 drive6 drive12 drive10 drive7 drive16 drive14 |
| 16 | 8 | RAIDZ2 | raidz2 |
| | | | drive1 drive3 drive4 drive2 drive8 drive5 drive6 drive12 |
| | | | raidz2 drive10 drive7 drive16 drive14 drive9 drive11 |
| | | | drive13 drive15 |

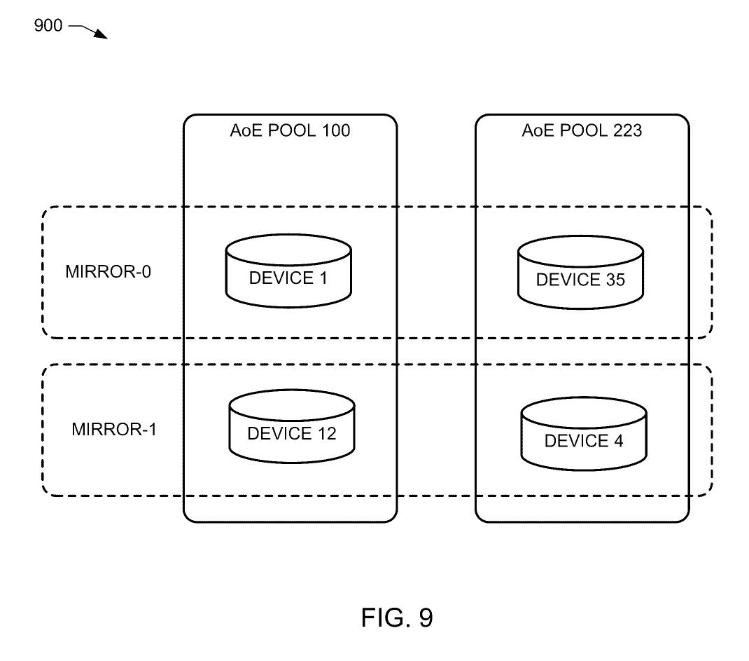

FIGS. 9 to 11 show diagrams of examples of drive assignment that may be performed by the node manager 110 and/or the pool planner 117 of FIGS. 1 to 3 and 8, according to example embodiments of the present disclosure. Specifically, FIG. 9 shows a build configuration 900 where the pool planner 117 identified four drives (e.g., device 1, device 4, device 12, and device 35 of the devices 114 of FIG. 1) as being available drives 806. The node manager 110 determines there are four total drives needed, with two drives per set and a MIRROR redundancy. For MIRROR-0, the node manager 110 is configured to select device 1 and device 35, which are in separate AoE pools (i.e., respective pools 100 and 223). For MIRROR-1, the node manager 110 is configured to select device 12 and device 4, which are also in separate AoE pools. Such an assignment of devices provides maximum path diversity for each of the mirrors.

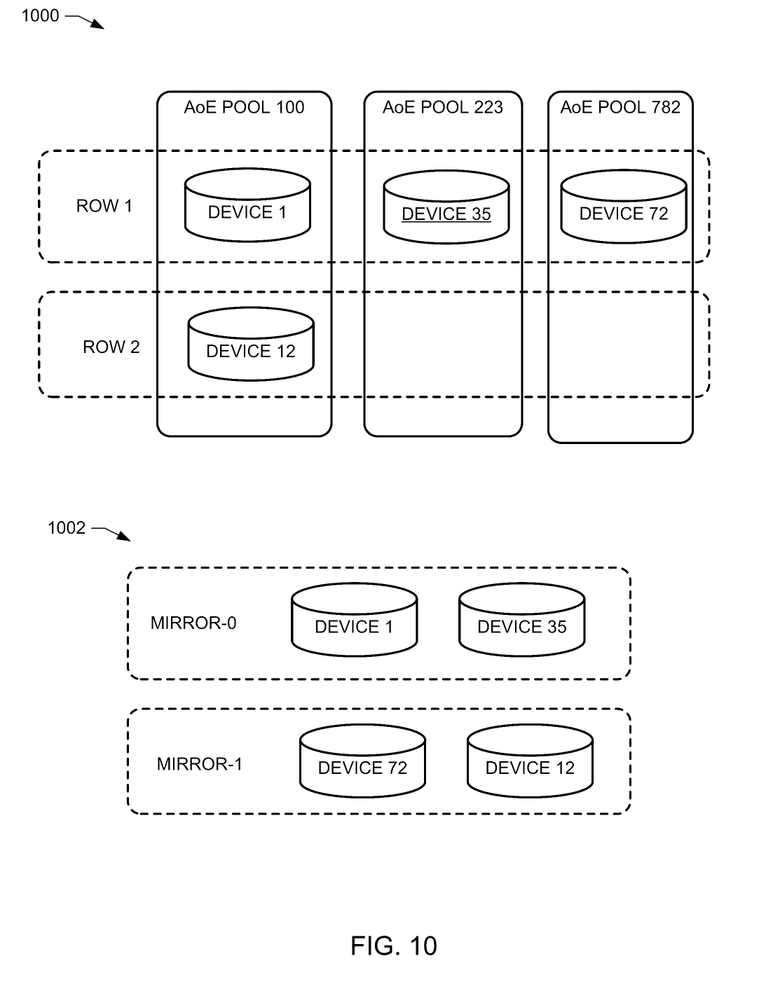

In FIG. 10, the example node manager 110 creates a table 1000, where each column includes a different AoE pool number. The node manager 110 assigns to each row one device that is associated with or located at the respective AoE pool number. The node manage 110 is configured to progress across the first row (from left to right) and subsequently the second row to assign the devices to MIRROR-0 and MIRROR-1. Specifically as shown in configuration 1002, device 1 and device 35 respectively from AoE pool numbers 100 and 223 are assigned by the node manager 110 to MIRROR-0, which is specified to have two devices per set. The node manager 110 then assigns device 72 from the 782 AoE pool and the next device 12 from the 100 AoE pool to MIRROR-1.

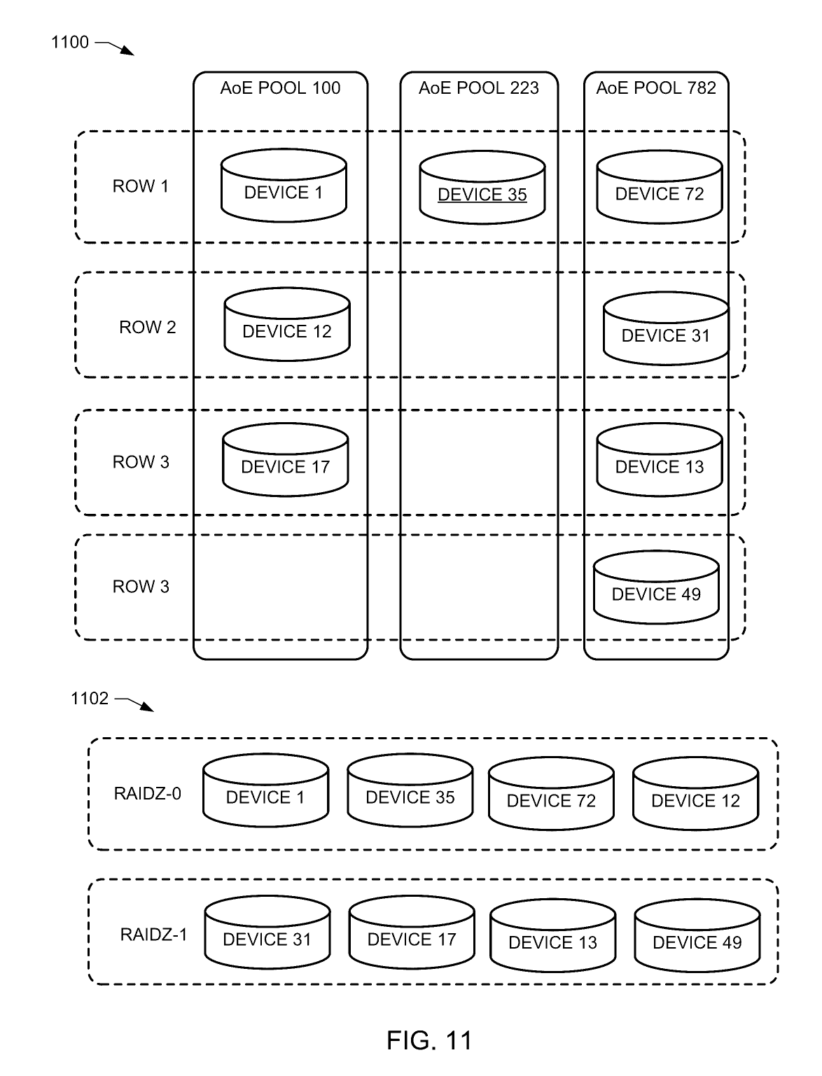

FIG. 11 shows a diagram where the example node manager 110 creates a table 1100, where each column includes a different AoE pool number. In this illustrated embodiment, eight total drives are needed, with four drives per set and RAIDZ1 redundancy being specified. The node manager 110 assigns to each row one device that is associated with or located at the respective AoE pool number. The node manage 110 is configured to progress across the first row (from left to right) and subsequently the second row to the fourth row to assign the devices to RAIDZ-0 and RAIDZ-1. Specifically as shown in configuration 1102, device 1, device 35, device 72, and device 12 respectively from AoE pool numbers 100, 223, and 782 are assigned by the node manager 110 to RAIDZ-0, which is specified to have four devices per set. The node manager 110 then assigns device 13, device, 17, device 13, and device 49 from the 100 AoE pool and the 782 AoE pool to RAIDZ-1.

In addition to the redundancy algorithms and/or filters discussed above, the example node manager 110 may also be configured to apply or use virtual pool diversity rules. In some instances, virtual pools may only be built with AoE LUs that have non-virtual storage backing. For CorOS 8.0.0, such a limitation may restrict virtual pools to only be configured from AoE LUs on CorOS 8.0.0 physical pools. Another rule may provide restrictions if there is no pool redundancy. This rule may specify, for example, that the physical pool backing the AoE LUs must be redundant (MIRROR, RAIDZ*) and cannot have redundancy=NONE. Thus it would not possible for the pool planner 117 or node manager 110 to build a virtual pool with zero redundancy. In another instance, a lack of virtual redundancy may cause all drives in a pool to have the same physical pool redundancy. In another example, if the redundancy backing is not specified, the preferred order of filtering is highest redundancy first: RAIDZ3, RAIDZ2, MIRROR, RAIDZ1, etc. In another example, the node manager 110 may include a rule specifying that MIRROR-2 is to be used if a virtual pool is redundant and related to CorOS 8.0.0. In some instances, the node manager 110 may be configured to use AoE pool numbers to further restrict pool use to certain redundancies. Additionally or alternatively, the node manager 110 may be configured to mirror across different physical pool redundancy types.

In an alternative example, the node manager 110 may provide more precise control over the exact placement of each drive within a pool or set. Initially, the node manager 110 and/or the pool planner 117 may be used to carefully select one or more filters to determine how pool diversity is to be achieved. In this example, the node manager 110 is configured to initially create an initial pool of drives from one or more AoE pool numbers. Then, the node manager 110 is configured to expand the pool to include other AoE pool numbers. In an example, the node manager 110 may determine the following configuration of drives (shown below in Table 5) to generate a 2-way mirror using 16 drives that can survive a complete pool failure. In this example, more precise control is needed to determine a configuration of drives that could survive a complete pool failure without data loss.

TABLE 5
Example: 2-Way Mirror with 16 Drives

| | | | | | zpool create CLI |
|---|---|---|---|---|---|
| Step | drives_needed | drives_per_set | redundancy | aoe_pool_nums | pool config |
| 1. create | 8 | 2 | MIRROR | [“100”, “224”] | mirror drive1 drive3 |
| initial | | | | | mirror drive2 drive8 |
| pool | | | | | mirror drive6 drive12 |
| | | | | | mirror drive7 drive16 |
| 2. | 8 | 2 | MIRROR | [“100”, “392”] | mirror drive9 drive4 |
| expand | | | | | mirror drive11 drive5 |
| pool | | | | | mirror |
| | | | | | drive13 drive10 |
| | | | | | mirror |
| | | | | | drive15 drive14 |

After determining a pool configuration, the example node manager 110 and/or the pool planner 117 of FIGS. 1 to 3 and 8 is configured to create the one or more storage pools. In some examples, the node manager 110 and/or the pool planner 117 is configured to use the procedure 400 described in connection with FIGS. 4A and 4B to create a storage pool. In these examples, the steps 410 and 412 are carried out using the filters 808 described above in connection with FIG. 8. In other embodiments, the example node manager 110 and/or the pool planner 117 may be configured with the following code below to build the one or more pools with drive placement specified to increase path diversity. In the examples below, the driver assignment is added as a configuration to the specified parameters.

PHYSICAL pool with one drive

{

“type”: “request”,
“synchronous”: true,
“command”: “pool_create_auto”,
“parameters”: {

“name”: “mypool”,
“redundancy”: “NONE”,
“drives_per set”: “1”,
“drives_needed”: “1”,
“kind”: “PHYSICAL”,
“intent”: “BLOCK”,
“aoe_pool_num”: “99”

}

}

PHYSICAL pool with two mirrored drives

{

“type”: “request”,
“synchronous”: true,
“command”: “pool_create_auto”,
“parameters”: {

“name”: “mypool”,
“redundancy”: “MIRROR”,
“drives_per_set”: “2”,
“drives_needed”: “2”,
“kind”: “PHYSICAL”,
“intent”: “BLOCK”,
“aoe_pool_num”: “99”

}

}

PHYSICAL pool with RAIDZ2-6

{

“type”: “request”,
“synchronous”: true,
“command”: “pool_create_auto”,
“parameters”: {

“name”: “mypool”,
“redundancy”: “RAIDZ2”,
“drives_per_set”: “6”,
“drives_needed”: “6”,
“kind”: “PHYSICAL”,
“intent”: “BLOCK”,
“aoe_pool_num”: “99”

}

}

PHYSICAL pool with 3x RAIDZ2-6

{

“type”: “request”,
“synchronous”: true,
“command”: “pool_create_auto”,
“parameters”: {

“name”: “mypool”,
“redundancy”: “RAIDZ2”,
“drives_per_set”: “6”,
“drives_needed”: “18”,
“kind”: “PHYSICAL”,
“intent”: “BLOCK”,
“aoe_pool_num”: “99”

}

}

VIRTUAL pool with 10 drives

{

“type”: “request”,
“synchronous”: true,
“command”: “pool_create_auto”,
“parameters”: {

“name”: “mypool”,
“redundancy”: “NONE”,
“drives_per set”: “1”,
“drives_needed”: “10”,
“kind”: “VIRTUAL”,
“intent”: “FILE”

}

}

VIRTUAL pool with 10 drives backed by RAIDZ2

{

“type”: “request”,
“synchronous”: true,
“command”: “pool_create_auto”,
“parameters”: {

“name”: “mypool”,
“redundancy”: “NONE”,
“drives_per set”: “1”,
“drives_needed”: “10”,
“kind”: “VIRTUAL”,
“intent”: “FILE”,
“backing_redundancy”: “RAIDZ2”

}

}

### Scalable Pool Planner Embodiment

As discussed above, the pool planner 117 of FIGS. 1 to 3 and 8 determines which of the devices 114 are to be configured in a storage pool. However, configuring hundreds of physical storage pools may consume more processing bandwidth than is available at the pool planner 117. FIG. 2 shows a diagram of a scalable pool planner in which each storage node may have a local pool planner 1202 configured to create diverse storage pools from among devices or portions of devices related to the storage node. In the illustrated embodiment, the pool planner 117 operates as a global pool planner configured to scale provisioning of pools among the local pool planners 1202 at the storage nodes. Such a configuration enables the global pool planner 117 to configure or manage the creation of hundreds of physical storage pools (potentially across multiple nodes) to setup a virtual storage pool based on end-user (e.g., third party) defined storage requirements. The global pool planner 117 is also configured to coordinate with the local pool planners 1202 to leverage existing physical storage pools in addition to provisioning new storage pools in the event of a virtual storage pool expansion. Moreover, the global pool planner 117 operates as an interface to the node manager 110 to automatically provision (or re-use) physical storage pools to expand virtual storage pools at user-defined capacity watermarks.

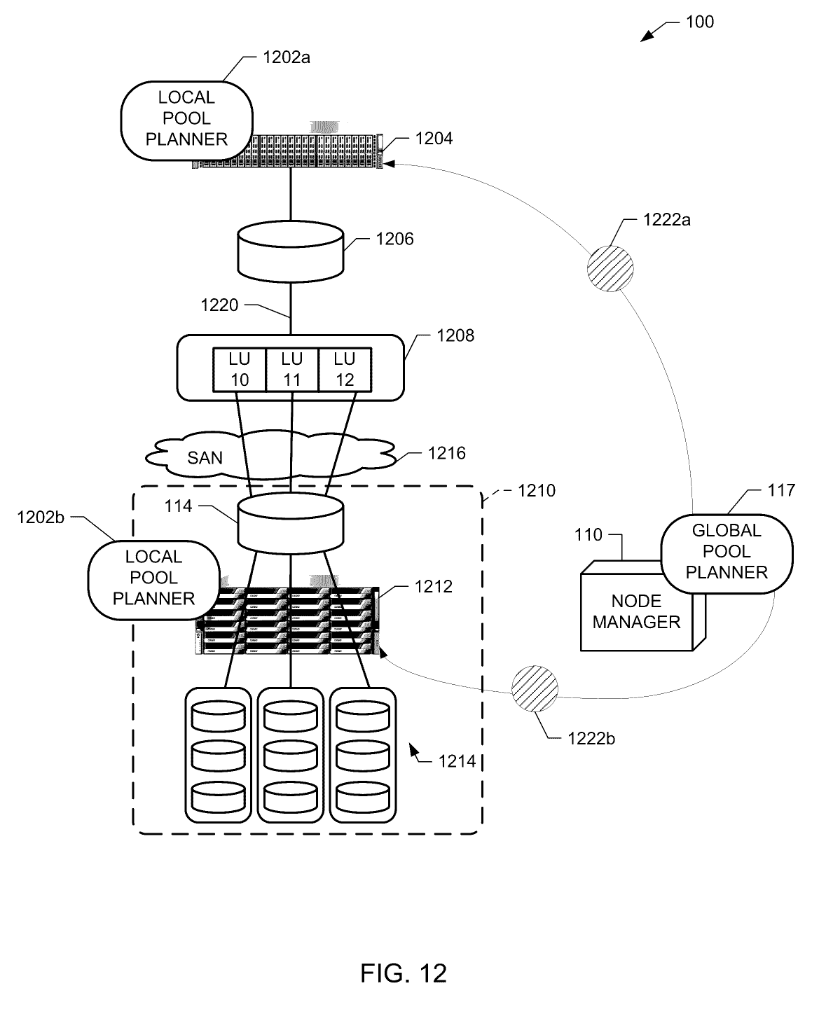

The storage service environment 100 of FIG. 12 includes the devices 114 within a storage pool that includes underlying pools of physical drives or devices 114. The storage pools and physical drives may be partitioned or organized into a two-tier architecture or system for a virtual storage node (“VSN”) 1204. In an illustrated example, in a top tier, the VSN 1204 includes a storage pool 1206 (among other storage pools not shown), which includes the logical volume 1208 having logical units (“LUs”) 10, 11, and 12 (e.g., virtual representations of LUs assigned or allocated to the underlying devices 114). As illustrated, in a lower tier, the LUs are assigned portions of one or more devices 114 (e.g., a HDD device) in a physical storage pool 1210. The devices 114 include redundant physical storage node 1212 each having at least one redundant physical storage group 1214 with one or more physical drives. The top tier is connected to the lower tier via an Ethernet storage area network (“SAN”) 1216.

The redistribution of LUs between the physical storage pools 1210 associated with the storage pool 1206 enables a storage provider to offer non-disruptive data storage services. For instance, a storage pool may be disruption free for changes to performance characteristics of a physical storage pool. In particular, a storage pool may be disruption free (for clients and other end users) during a data migration from an HDD pool to an SSD pool. In another instance, a storage pool may remain disruption free for refreshes to physical storage node hardware (e.g., devices 114. In yet another instance, a storage pool may remain disruption free for rebalancing of allocated storage pool storage in the event of an expansion to the physical storage node 1212 to relieve hot-spot contention. Further, the use of the VSN 1204 to redistribute Ethernet LUs enables re-striping storage pool contents in the event of excess fragmentation of physical storage pools due to a high rate of over-writes and/or deletes in the absence of a file system trim command (e.g., TRIM) and/or an SCSI UNMAP function.

As shown, the physical storage node 1212 and the VSN 1204 are provisioned in conjunction with each other to provide at least a two-layer file system that enables additional physical storage devices or drives to be added or storage to be migrated without renumbering or readdressing the chassis or physical devices/drives. The physical storage node 1212 includes files, blocks, etc. that are partitioned into pools (e.g., the service pools 1206) of shared configurations. Each service pool 1206 has a physical storage node 1212 service configuration that specifies how data is stored within (and/or among) one or more logical volumes of the VSN 1204. The physical storage node 1212 includes a file system and volume manager to provide client access to data stored at the VSN 1204 while hiding the existence of the VSN 1204 and the associated logical volumes. Instead, the physical storage node 1212 provides clients data access that appears similar to single layer file systems.

The VSN 1204 is a virtualized storage network that is backed or hosted by physical data storage devices and/or drives. The VSN 1204 includes one or more storage pools 1206 that are partitioned into slices (e.g., LUs) or logical unit numbers (“LUNs”)) that serve as the logical volumes at the physical storage node 1212. The storage pool 1206 is provisioned based on a storage configuration, which specifies how data is to be stored on at least a portion of the hosting physical storage device. Generally, each storage pool 1206 within the VSN 1206 is assigned an identifier (e.g., a shelf identifier), with each LU being individually addressable. A logical volume is assigned to the physical storage node 1212 by designating or otherwise assigning the shelf identifier of the storage pool and one or more underlying LUs to a particular service pool 1206 within the physical storage node 1212.

As shown in FIG. 12, the physical storage node 1212 and the VSN 1204 each includes a local pool planner 1202a and 1202b, which are configured to operate on resources located on each node. The VSN 1204 has access to the physical storage node 1212 via data path 1220. Accordingly, the local pool planner 1202a at the VSN 1204 cannot create or provision resources that have not already been provisioned locally on the physical storage node 1212. The global pool planner 117 is configured to overcome the limitations of the local pool planner 1202a by being configured to provision a virtual storage pool across multiple physical storage node 1212 using respective VSNs 1204. Such a configuration enables a third-party to provision an entire data center with a REST call 1222.

The global pool planner 117 may include a REST interface that is utilized by the node manager 110 to automatically provision resources when certain events occur. The events can include, for example, running out of capacity at the storage pool 1206, rebalancing Ethernet LUs of a virtual service pool when a new physical storage node 1212 joins a network, or reaching a performance threshold. In some instances, the global pool planner 117 and/or the node manager 110 may retrieve a list of the VSNs 1204 and/or the physical storage nodes 1212 from an EtherCloud and/or the SAN 1216 via REST.

### CONCLUSION

It will be appreciated that all of the disclosed methods and procedures described herein can be implemented using one or more computer programs or components. These components may be provided as a series of computer instructions on any computer-readable medium, including RAM, ROM, flash memory, magnetic or optical disks, optical memory, or other storage media. The instructions may be configured to be executed by a processor, which when executing the series of computer instructions performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An apparatus for configuring a storage pool comprising:
a pool planner processor configured to:
receive storage requirement information,
determine, as available storage devices, storage devices within a storage system that have availability to be placed into the storage pool,
apply a first filter to the available storage devices to eliminate a first set of the available storage devices and determine remaining storage devices, the first filter including a first portion of the storage requirement information,
apply a second filter to the remaining storage devices after the first filter to eliminate a second set of the remaining storage devices, the second filter including a second portion of the storage requirement information, and
designate the storage devices remaining after the second filter as identified storage devices
a node manager processor configured to:
receive the storage requirement information for the storage pool from a third-party,
transmit the storage information to the pool planner processor,
create the storage pool based on the storage requirement information using at least one of the identified storage devices, and
make the storage pool available to the third-party.

2. The apparatus of claim 1, wherein the node manager processor is configured to create the storage pool based on the storage requirement information by:
determining of number of storage devices needed;
determining a number of storage devices per set;
determining a redundancy;
selecting the determined number of storage devices among the identified storage devices;
configuring the selected storage devices into the at least one determined set; and
configuring the selected storage devices based on the determined redundancy.

3. The apparatus of claim 2, wherein the node manager processor is configured to select the determined number of storage devices among the identified storage devices to maximize path diversity among the selected storage devices.

4. The apparatus of claim 2, wherein the redundancy includes at least one of a mirror configuration, a RAIDZ1 configuration, a RAIDZ2 configuration, and no redundancy.

5. The apparatus of claim 1, wherein the node manager processor is configured to convert the storage requirement information into at least one of an attribute-value pair or JavaScript Object Notation (“JSON”) before transmitting the storage requirement information to the pool planner processor.

6. The apparatus of claim 1, wherein the node manager processor is configured to apply the first filter before the second filter conditioned on determining that the first filter will eliminate more storage devices than the second filter.

7. The apparatus of claim 1, wherein the pool planner processor is configured to:
determine a configuration of a storage controller to identify second storage requirement information; and
combine the second storage requirement information with the storage requirement information.

8. The apparatus of claim 7, wherein the second storage requirement information includes at least one of single-node vs multimode cluster information, existing in-use device information, sharable vs non-sharable device information, reserved device information, and redundancy backing virtual device information.

9. The apparatus of claim 1, wherein the pool planner processor is configured to create an eliminated storage device data structure that includes at least one of:
an identifier of the first filter, an identifier of the eliminated storage device within the first set, and a text string added by the first filter to the eliminated storage device, and
an identifier of the second filter, an identifier of the eliminated storage device within the second set, and a text string added by the second filter to the eliminated storage device.

10. The apparatus of claim 1, wherein the pool planner processor is configured to:
determine if the first set of the available storage devices includes all of the available storage devices; and
conditioned on the first set of the available storage devices including all of the available storage devices, create an error data structure including at least one of an identifier of the first filter, the first portion of the storage requirement information, and identifiers of first set of the available storage devices.

11. The apparatus of claim 1, wherein the pool planner processor is configured to:
determine if the second set of remaining storage devices includes all of the first set of available storage devices; and
conditioned on the second set of remaining storage devices including all of the first set of available storage devices, create an error data structure including at least one of an identifier of the second filter, the second portion of the storage requirement information, and identifiers of the second set of remaining storage devices.

12. The apparatus of claim 1, wherein the storage devices within the storage system include at least one of storage drives, storage disks, physical blocks, virtual blocks, physical files, virtual files, and memory devices including at least one of HDDs, SSDs, AoE Logical Units, SAN Logical Units, ramdisk, and file-based storage devices.

13. The apparatus of claim 1, wherein the storage pool includes at least one of a new storage pool to be provisioned and an existing storage pool to be expanded based on the storage requirement information.

14. The apparatus of claim 1, wherein the pool planner processor is configured to:
apply a third filter to determine the available storage devices; and
apply a fourth filter to determine formatted specs based on the received storage requirement information.

15. A method for configuring a storage pool comprising:
receiving storage requirement information for the storage pool from a third-party;
determining, as available storage devices, storage devices within a storage system that have availability to be placed into the storage pool;
first filtering, based on a first portion of the storage requirement information, the available storage devices to (i) eliminate a first set of the available storage devices and (ii) determine remaining storage devices;
second filtering, based on a second portion of the storage requirement information, the remaining storage devices after the first filtering to eliminate a second set of the remaining storage device;
designating the storage devices remaining after the first and second filtering as identified storage devices;
creating the storage pool based on the storage requirement information using at least one of the identified storage devices; and
making the storage pool available to the third-party.

16. The method of claim 15, wherein creating the storage pool based on the storage requirement information includes:
determining of number of storage devices needed;
determining a number of storage devices per set;
determining a redundancy;
selecting the determined number of storage devices among the identified storage devices;
configuring the selected storage devices into the at least one determined set; and
configuring the selected storage devices based on the determined redundancy.

17. The method of claim 16, wherein the determined number of storage devices is selected among the identified storage devices to maximize path diversity among the selected storage devices.

18. The method of claim 17, wherein the maximized path diversity is determined by:
determining device paths to each of the identified storage devices;
creating a table with each different device path is listed in a separate column and each row includes one identified storage device that is located at the respective device path; and
selecting the determined number of storage devices among the identified storage devices for the at least one determined set in a round-robin manner starting with a first row in the table.

19. The method of claim 15, wherein the first portion of the storage requirement information includes a minimum storage size and the second portion of the storage requirement information includes a vendor identifier.

20. The method of claim 15, wherein the storage requirement information includes at least one of a property, an attribute, a value, information including at least one of an indication of a physical storage pool or a virtual storage pool, intent information (e.g., file or block), redundancy information, a number of devices or drives desired, a media type, a physical redundancy type, a minimum revolutions per minute (“RPM”) for the devices, a minimum drive or device size, a like drive or device indication, an AoE pool number (or multiple AoE pool numbers), product name, and/or a vendor name.
